(19) United States
(12) Patent Application Publication
(10) Pub. No.: US 2026/0283073 A1
(43) Pub. Date: Sep. 24, 2026

(54) HYDRAULIC CONTROL SYSTEM AND ASSOCIATED METHODS TO CONTROL A DRUM AND SPINDLES OF A COTTON HARVESTER

(71) Applicants: Deere & Company, Moline, IL (US); Iowa State University Research Foundation, Inc., Ames, IA (US)

(72) Inventors: Brandon C. Carlson, Ankeny, IA (US); Jeffrey Clark Askey, Boone, IA (US); Juan Andrés Martín Fernández, Illescas (ES); Hector H. Ballester, Getafe (ES); Steven D. Wallestad, Ankeny, IA (US); Kurt D. Gustafson, Altoona, IA (US); Victor Gonzalez Huerta, Coslada (ES)

(21) Appl. No.: 19/547,309

(22) Filed: Feb. 23, 2026

Related U.S. Application Data
(60) Provisional application No. 63/775,131, filed on Mar. 20, 2025.

(51) Int. Cl. A01D 46/08; A01D 69/03

(52) U.S. Cl. CPC A01D 46/085; A01D 69/03

(57) ABSTRACT

A hydraulic control system and associated methods to control a drum and spindles of a cotton harvester are described. An example apparatus includes a first motor operatively coupled to a drum and spindles of a row unit of a cotton harvester, a second motor operatively coupled to the drum, a pump operatively coupled to the first motor, a valve operatively coupled to the second motor, and at least one processor circuit configured to generate a first control signal for the pump, wherein the pump is configured to generate a first fluid flow to the first motor to cause rotation of the spindles, and generate a second control signal for the valve, wherein the valve is configured to control a second fluid flow to the second motor, the first motor and the second motor configured to cause rotation of the drum.

### RELATED APPLICATION

This patent claims the benefit of U.S. Provisional Patent Application No. 63/775,131, which was filed on Mar. 20, 2025. U.S. Provisional Patent Application No. 63/775,131 is hereby incorporated herein by reference in its entirety. Priority to U.S. Provisional Patent Application No. 63/775,131 is hereby claimed.

### FIELD OF THE DISCLOSURE

This disclosure relates generally to agricultural vehicles and, more particularly, to a hydraulic control system and associated methods to control a drum and spindles of a cotton harvester.

### BACKGROUND

Cotton harvesters are agricultural vehicles that may be used to harvest cotton from a field. Some cotton harvesters include row units including rotating drums and spindles to gather cotton material from planted rows as the cotton harvester travels forward in the field. The row units then convey the gathered cotton material to an internal compartment of the cotton harvester, where the cotton material can be stored and/or formed into modules. Rotational speeds of the drums and spindles may be selected and/or adjusted based on a forward travel speed of the cotton harvester.

### SUMMARY

A first example apparatus includes a first motor operatively coupled, via a variable transmission gearbox, to a drum and spindles of a row unit of a cotton harvester, a second motor operatively coupled to the drum via the variable transmission gearbox, a pump operatively coupled to the first motor, a valve operatively coupled to the second motor, and at least one processor circuit configured to generate a first control signal for the pump, wherein the pump is configured to generate, responsive to the first control signal, a first fluid flow to the first motor, the first motor configured to cause rotation of the spindles based on the first fluid flow, and generate a second control signal for the valve, wherein the valve is configured to control, responsive to the second control signal, a second fluid flow to the second motor, the first motor and the second motor configured to cause rotation of the drum based on the first fluid flow and the second fluid flow.

A second example apparatus includes the first example apparatus, wherein the pump is configured to adjust a first flow rate and a flow direction of the first fluid flow based on the first control signal, and the valve is configured to adjust a second flow rate of the second fluid flow based on the second control signal.

A third example apparatus includes the first example apparatus, wherein one or more of the at least one processor circuit is further configured to determine, based on first sensor data from a first sensor operatively coupled to the variable transmission gearbox, a first calculated rotational speed of the spindles, determine, based on the first sensor data and second sensor data from a second sensor operatively coupled to the variable transmission gearbox, a second calculated rotational speed of the drum, generate the first control signal based on a first difference between the first calculated rotational speed and a first target rotational speed for the spindles, and generate the second control signal based on a second difference between the second calculated rotational speed and a second target rotational speed for the drum.

A fourth example apparatus includes the third example apparatus, wherein one or more of the at least one processor circuit is further configured to adjust at least one of the first target rotational speed or the second target rotational speed based on a cotton harvesting metric, the cotton harvesting metric including at least one of a mass flow rate of cotton material into the cotton harvester, a loss associated with the cotton material, or a quality of the cotton material.

A fifth example apparatus includes the first example apparatus, wherein one or more of the at least one processor circuit is further configured to execute a machine learning model based on a metric associated with the cotton harvester, adjust a value of at least one of a first lookup table or a second lookup table based on a result of the execution, wherein the first lookup table relates first rotational speeds of the first motor to first current values for the first control signal, and the second lookup table relates second rotational speeds of the second motor to second current values for the second control signal, select, based on the first lookup table, a first current value for the first control signal, and select, based on the second lookup table, a second current value for the second control signal.

A sixth example apparatus includes the fifth example apparatus, wherein the metric includes at least one of an oil temperature of the cotton harvester, a unit type of the cotton harvester, or an age of one or more components of the cotton harvester.

A seventh example apparatus includes the first example apparatus, wherein the row unit is a first row unit, the valve is a first valve, and wherein one or more of the at least one processor circuit is further configured to generate a third control signal for a second valve fluidly coupled between the first valve and a second row unit of the cotton harvester, wherein the second valve is configured to, responsive to the third control signal, redirect a portion of the second fluid flow to the second row unit.

A first example non-transitory machine-readable medium includes instructions that, when executed, cause at least one processor circuit to generate a first control signal for a pump operatively coupled to a first motor, the first motor operatively coupled, via a variable transmission gearbox, to a drum and spindles of a row unit of a cotton harvester, wherein the pump is configured to generate, responsive to the first control signal, a first fluid flow to the first motor, the first motor configured to cause rotation of the spindles based on the first fluid flow, and generate a second control signal for a valve operatively coupled to a second motor, the second motor operatively coupled to the drum via the variable transmission gearbox, wherein the valve is configured to control, responsive to the second control signal, a second fluid flow to the second motor, the first motor and the second motor configured to cause rotation of the drum based on the first fluid flow and the second fluid flow.

A second example non-transitory machine-readable medium includes the first example non-transitory machine-readable medium, wherein the pump is configured to adjust a first flow rate and a flow direction of the first fluid flow based on the first control signal, and the valve is configured to adjust a second flow rate of the second fluid flow based on the second control signal.

A third example non-transitory machine-readable medium includes the first example non-transitory machine-readable medium, wherein the instructions, when executed, cause one or more of the at least one processor circuit to determine, based on first sensor data from a first sensor operatively coupled to the variable transmission gearbox, a first calculated rotational speed of the spindles, determine, based on the first sensor data and second sensor data from a second sensor operatively coupled to the variable transmission gearbox, a second calculated rotational speed of the drum, generate the first control signal based on a first difference between the first calculated rotational speed and a first target rotational speed for the spindles, and generate the second control signal based on a second difference between the second calculated rotational speed and a second target rotational speed for the drum.

A fourth example non-transitory machine-readable medium includes the third example non-transitory machine-readable medium, wherein the instructions, when executed, cause one or more of the at least one processor circuit to adjust at least one of the first target rotational speed or the second target rotational speed based on a cotton harvesting metric, the cotton harvesting metric including at least one of a mass flow rate of cotton material into the cotton harvester, a loss associated with the cotton material, or a quality of the cotton material.

A fifth example non-transitory machine-readable medium includes the first example non-transitory machine-readable medium, wherein the instructions, when executed, cause one or more of the at least one processor circuit to execute a machine learning model based on a metric associated with the cotton harvester, adjust a value of at least one of a first lookup table or a second lookup table based on a result of the execution, wherein the first lookup table relates first rotational speeds of the first motor to first current values for the first control signal, and the second lookup table relates second rotational speeds of the second motor to second current values for the second control signal, select, based on the first lookup table, a first current value for the first control signal, and select, based on the second lookup table, a second current value for the second control signal.

A sixth example non-transitory machine-readable medium includes the fifth example non-transitory machine-readable medium, wherein the metric includes at least one of an oil temperature of the cotton harvester, a unit type of the cotton harvester, or an age of one or more components of the cotton harvester.

A seventh example non-transitory machine-readable medium includes the first example non-transitory machine-readable medium, wherein the row unit is a first row unit, the valve is a first valve, and wherein the instructions, when executed, cause one or more of the at least one processor circuit to generate a third control signal for a second valve fluidly coupled between the first valve and a second row unit of the cotton harvester, wherein the second valve is configured to, responsive to the third control signal, redirect a portion of the second fluid flow to the second row unit.

A first example method includes generating a first control signal for a pump operatively coupled to a first motor, the first motor operatively coupled, via a variable transmission gearbox, to a drum and spindles of a row unit of a cotton harvester, wherein the pump is configured to generate, responsive to the first control signal, a first fluid flow to the first motor, the first motor configured to cause rotation of the spindles based on the first fluid flow, and generating a second control signal for a valve operatively coupled to a second motor, the second motor operatively coupled to the drum via the variable transmission gearbox, wherein the valve is configured to control, responsive to the second control signal, a second fluid flow to the second motor, the first motor and the second motor configured to cause rotation of the drum based on the first fluid flow and the second fluid flow.

A second example method includes the first example method, further including determining, based on first sensor data from a first sensor operatively coupled to the variable transmission gearbox, a first calculated rotational speed of the spindles, determining, based on the first sensor data and second sensor data from a second sensor operatively coupled to the variable transmission gearbox, a second calculated rotational speed of the drum, generating the first control signal based on a first difference between the first calculated rotational speed and a first target rotational speed for the spindles, and generating the second control signal based on a second difference between the second calculated rotational speed and a second target rotational speed for the drum.

A third example method includes the second example method, further including adjusting at least one of the first target rotational speed or the second target rotational speed based on a cotton harvesting metric, the cotton harvesting metric including at least one of a mass flow rate of cotton material into the cotton harvester, a loss associated with the cotton material, or a quality of the cotton material.

A fourth example method includes the third example method, further including executing a machine learning model based on a metric associated with the cotton harvester, adjusting a value of at least one of a first lookup table or a second lookup table based on a result of the execution, the first lookup table to relate first rotational speeds of the first motor to first current values for the first control signal, the second lookup table to relate second rotational speeds of the second motor to second current values for the second control signal, selecting, based on the first lookup table, a first current value for the first control signal, and selecting, based on the second lookup table, a second current value for the second control signal.

A fifth example method includes the fourth example method, wherein the metric includes at least one of an oil temperature of the cotton harvester, a unit type of the cotton harvester, or an age of one or more components of the cotton harvester.

A sixth example method includes the first example method, wherein the row unit is a first row unit, the valve is a first valve, and further including generating a third control signal for a second valve fluidly coupled between the first valve and a second row unit of the cotton harvester, wherein the second valve is configured to, responsive to the third control signal, redirect a portion of the second fluid flow to the second row unit.

### BRIEF DESCRIPTION OF THE DRAWINGS

FIG. 1 is a side view of an example cotton harvester in which examples described herein may be implemented.

FIG. 2 is a perspective view of the cotton harvester of FIG. 1 implementing an example hydraulic system and example system control circuitry in accordance with teachings of this disclosure.

FIG. 3 is a schematic illustration of the example hydraulic system of FIG. 2.

FIG. 4 is a schematic illustration of an example spindle drive system of the hydraulic system of FIGS. 2 and 3.

FIG. 5 is a schematic illustration of an example drum drive system of the hydraulic system of FIGS. 2 and 3.

FIG. 6 is an enlarged schematic illustration of a first auxiliary loop of FIG. 5.

FIG. 7 is a block diagram of an example implementation of the system control circuitry of FIGS. 2-6.

FIG. 8A is a schematic illustration of an example spindle pump control loop that may be implemented by the system control circuitry of FIGS. 2-7 to control one or more components of the hydraulic system of FIGS. 2 and 3.

FIG. 8B illustrates a first example graph representative of a first feedforward model that may be utilized by the system control circuitry of FIGS. 2-7.

FIG. 9A is a schematic illustration of an example drum valve control loop that may be implemented by the system control circuitry of FIGS. 2-7 to control one or more components of the hydraulic system of FIGS. 2 and 3.

FIG. 9B illustrates a second example graph representative of a second feedforward model that may be utilized by the system control circuitry of FIGS. 2-7.

FIG. 10 is a schematic illustration of an example bypass valve control loop that may be implemented by the system control circuitry of FIGS. 2-7 to control one or more components of the hydraulic system of FIGS. 2 and 3.

FIG. 11 illustrates a third example graph representative of example front drum speeds relative to example ground speeds of the cotton harvester of FIGS. 1 and 2.

FIG. 12 illustrates a fourth example graph representative of example front spindle speeds relative to example ground speeds of the cotton harvester of FIGS. 1 and 2.

FIG. 13 is a flowchart representative of example machine readable instructions and/or example operations that may be executed, instantiated, and/or performed by example programmable circuitry to implement the system control circuitry of FIGS. 2-7.

FIG. 14 is a block diagram of an example processing platform including programmable circuitry structured to execute, instantiate, and/or perform the example machine readable instructions and/or perform the example operations of FIG. 13 to implement the system control circuitry of FIGS. 2-7.

FIG. 15 is a block diagram of an example implementation of the programmable circuitry of FIG. 14.

FIG. 16 is a block diagram of another example implementation of the programmable circuitry of FIG. 14.

In general, the same reference numbers will be used throughout the drawing(s) and accompanying written description to refer to the same or like parts. The figures are not necessarily to scale. Instead, the thickness of the layers or regions may be enlarged in the drawings. Although the figures show layers and regions with clean lines and boundaries, some or all of these lines and/or boundaries may be idealized. In reality, the boundaries and/or lines may be unobservable, blended, and/or irregular.

### DETAILED DESCRIPTION

Some agricultural vehicles, commonly referred to as cotton harvesters or cotton pickers, may be used to harvest cotton from a field. Cotton harvesters typically include a set of row units (e.g., cotton harvester row units) coupled to a front end of the cotton harvesters. As the cotton harvester travels forward along one or more rows of cotton plants in the field, the row units can operate to gather the cotton plants (or a portion thereof) into the cotton harvester for processing. Typically, a row unit includes spindles operatively coupled to respective drums. During operation of the cotton harvester, the drums rotate about respective first longitudinal axes (e.g., drum axes) of the drums, and the spindles rotate with the drums about the longitudinal axes. Further, the spindles can rotate about respective second longitudinal axes (e.g., spindle axes) extending radially outward from the respective drums, where the spindles are elongated along the respective second longitudinal axes.

When the spindles rotate with the respective drums about the drum axes and further rotate about the respective spindle axes, the rotating spindles separate seed cotton from the cotton plants and draw the seed cotton into elongate fibers. The row unit can further include a doffer that rotates in a counteracting manner relative to the spindles, such that rotation of the doffer removes harvested cotton material from the spindles. The cotton material is then transferred (e.g., using a vacuum tube and/or other conveying mechanism) to a module-forming area of the cotton harvester. Once a module of the cotton material is formed, the module can be ejected from the cotton harvester onto the field, and may be collected at a later time.

In many cotton harvesters, rotation speeds of the drums and spindles are mechanically linked, such that a change in the rotation speed of the drums results in a corresponding change in the rotation speed of the spindles. Further, the drum speeds (and, thus, the resulting spindle speeds) are typically directly proportional to a ground speed (e.g., a forward travel speed) of the cotton harvester. As a result, the spindle speeds may be reduced and/or limited based on the ground speed and/or the drum speeds, and such limitation of the spindle speeds may negatively impact picking efficiency and/or conveying capacity of the cotton harvester, particularly in varying and/or high yielding cotton conditions.

In recent years, some cotton harvesters have been developed to enable independent control of the drum speed (e.g., drum rotational speed) and spindle speed (e.g., spindle rotational speed) of a corresponding row unit. For instance, the drum and spindle speeds can be controlled independently to adapt to variations in crop and/or field conditions. As a result, independent control of the drum and spindle speeds can improve efficiency of a cotton harvesting operation by increasing mass flow rate of cotton material into the cotton harvester, reducing cotton loss (e.g., reducing an amount of unharvested cotton remaining in the field), etc.

Examples described herein enable independent control of the drum speed and spindle speed of a row unit (e.g., a cotton harvester row unit) of a cotton harvester. For example, an example system (e.g., a hydraulic control system) described herein includes a first motor (e.g., a spindle drive motor) operatively coupled, via a variable transmission gearbox, to a drum and associated spindles of the row unit. A second motor (e.g., a drum drive motor) is also operatively coupled to the drum via the variable transmission gearbox. In some examples, operation (e.g., rotation) of the first motor controls a spindle speed (e.g., a spindle rotational speed) of the spindles, and operation of the first and second motors controls a drum speed (e.g., a drum rotational speed) of the drum. In some examples, example system control circuitry is operatively coupled to a pump (e.g., a spindle drive pump) to control (e.g., via first control signal(s)) a first fluid flow to the first motor and, as a result, control a first drive speed and direction of the first motor. Further, the system control circuitry is operatively coupled to a valve (e.g., a drum drive control valve) to control (e.g., via second control signal(s)) a second fluid flow to the second motor and, as a result, control a second drive speed of the second motor. In some examples, by adjusting rotation of the first motor and/or the second motor, examples described herein can vary the spindle speeds and/or the drums speeds (e.g., relative to one another and/or to a ground speed of the cotton harvester). As a result, examples described herein can improve efficiency of a cotton harvesting operation by, for example, increasing the spindle speed (e.g., relative to the ground speed) to increase mass flow rate of cotton material into the cotton harvester, reduce cotton loss, etc.

In examples described herein, the drum speed is based on a relative drive speed between the first motor and the second motor. In some examples, the relative drive speed can be adjusted by adjusting a drive speed of the first motor in two rotational directions and/or by adjusting a drive speed of the second motor in only one direction (e.g., unidirectionally). Stated differently, the drum speed can be varied (e.g., within a range of operational speeds) by adjusting the first rotational speed of the first motor in either of the two rotational directions and/or by adjusting the second rotational speed of the second motor in only one direction (e.g., without reversing a rotational direction of the second motor). Because examples described herein do not necessitate reversal of the rotational direction of the second motor, a complexity of a hydraulic system operatively coupled to the second motor can be reduced (e.g., compared to a hydraulic system in which the second motor is drivable in two directions).

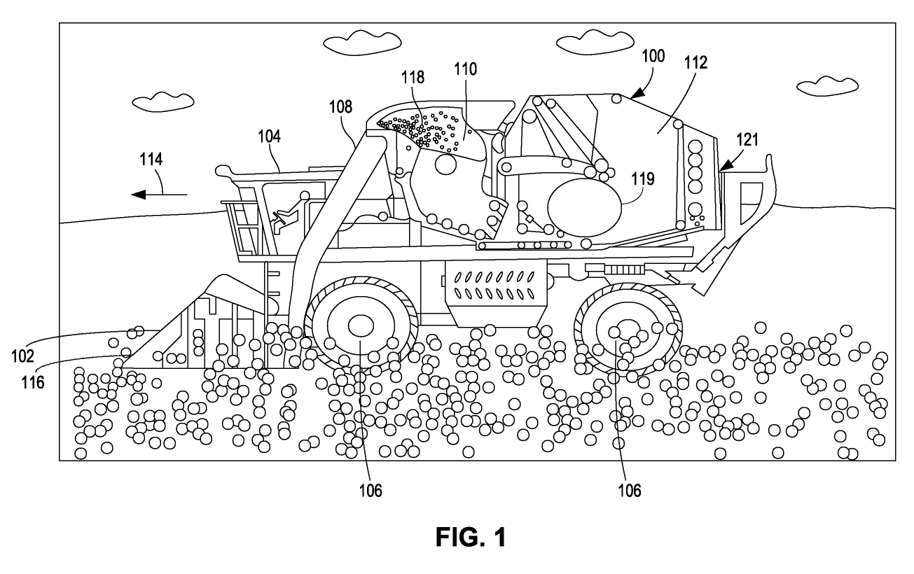

FIG. 1 is a side view of an example cotton harvester 100 in which examples described herein may be implemented. In the illustrated example of FIG. 1, the cotton harvester 100 includes a front end 102, a cabin (e.g., an operator cabin) 104, wheels 106, a conveyor mechanism 108, a cotton containment area 110, and a module forming area 112. An engine (or other power source) drives movement of cotton harvester 100 in a forward direction (e.g., indicated by arrow 114). The cotton harvester 100 further includes row units 116 coupled to the front end 102 of the cotton harvester 100. During operation, as the cotton harvester 100 moves in the forward direction 114 along rows of cotton plants in a field, the row units 116 can funnel cotton plants into the front end 102 and separate cotton material (e.g., seed cotton) 118 from the cotton plants. The conveyer mechanism 108 can convey (e.g., via vacuum pressure, positive air pressure, etc.) the cotton material 118 to the cotton containment area 110 and to the module forming area 112. In the module forming area 112, the cotton material 118 can be formed into a module (e.g., a cotton module) 119. In some examples, when a size of the module 119 reaches a threshold size, the module 119 can be ejected (e.g., via a rearward portion 121 of the cotton harvester 100) from the module forming area 112 onto the field.

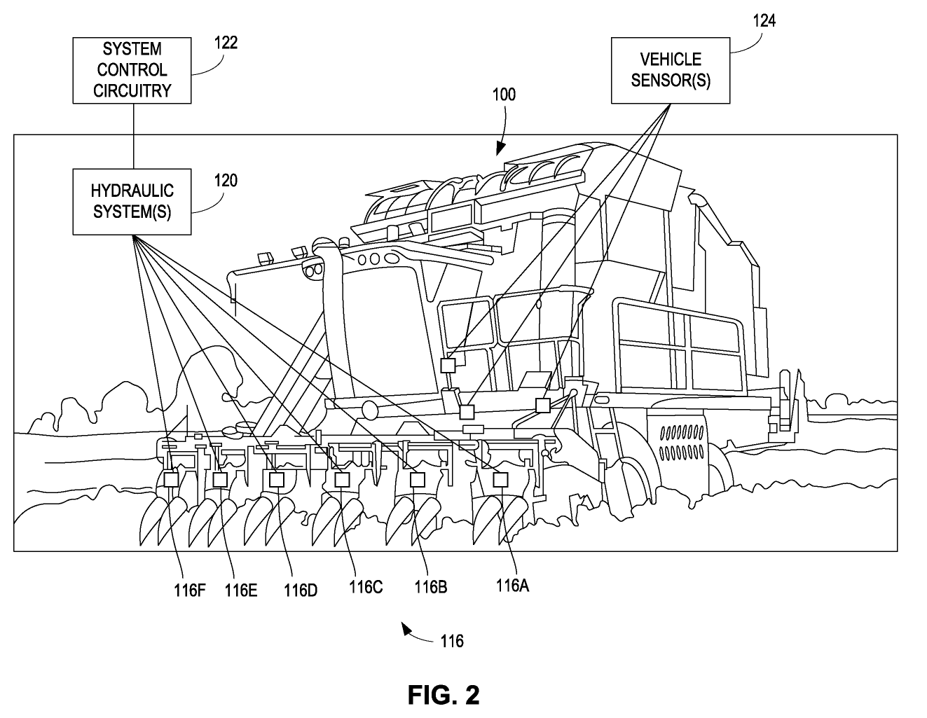

FIG. 2 is a perspective view of the cotton harvester 100 of FIG. 1. In the illustrated example of FIG. 2, the cotton harvester 100 includes six of the row units 116 (e.g., a first row unit 116A, a second row unit 116B, a third row unit 116C, a fourth row unit 116D, a fifth row unit 116E, and a sixth row unit 116F). In some examples, the cotton harvester 100 can include a different number of the row units 116 (e.g., four, five, seven or more, etc.). The row units 116 include spindles rotatably coupled to respective drums (e.g., rotating drums). The spindles can rotate with the drums about first longitudinal axes of the drums, and can further rotate about second longitudinal axes of the spindles (e.g., where the second longitudinal axes of the spindles extend radially from the respective drums). During operation of the cotton harvester 100, spindles on respective pairs of the drums rotate relative to one another to draw cotton plants into the row units 116. Further, rotation of the spindles along the second longitudinal axes of the spindles removes cotton material from the cotton plants and/or draws the cotton material into elongate fibers for further processing by the cotton harvester 100. In some examples, rotation speeds of the drums and the spindles are controllable via one or more motors (e.g., hydraulic motor(s)) operatively coupled to the drums and the spindles via gearboxes of the respective row units 116.

In the illustrated example of FIG. 2, the cotton harvester 100 includes one or more example hydraulic systems 120 operatively and/or fluidly coupled to one(s) of the row units 116. In some examples, the hydraulic system(s) 120 can provide and/or direct fluid (e.g., hydraulic fluid) to the motor(s) of the respective row units 116 to drive operation of the motor(s) and, as a result, control rotation of the corresponding drums and spindles. Further, example system control circuitry (e.g., hydraulic system control circuitry) 122 is operatively coupled to the hydraulic system(s) 120. In some examples, the system control circuitry 122 can control a rate and/or a direction of flow through the hydraulic system(s) 120 by opening, closing, and/or adjusting position(s) of one or more valves of the hydraulic system(s) 120 and/or by adjusting flow rate(s) of one or more pumps of the hydraulic system(s) 120. As a result, the system control circuitry 122 can control rotational speed and direction of the motor(s) and, thus, can control rotational speed and direction of the drums and/or spindles of the corresponding row units 116.

In the illustrated example of FIG. 2, the cotton harvester 100 further includes one or more example vehicle sensors 124 to measure and/or detect one or more metrics associated with the cotton harvester 100. For example, the vehicle sensor(s) 124 can include a mass flow sensor to measure a mass flow rate of cotton material into the cotton harvester 100, a loss sensor to measure a loss metric (e.g., an amount of unharvested cotton material remaining in a field), and/or one or more additional sensors (e.g., image sensor(s), radar sensor(s), etc.) to measure a quality of the cotton material. In such examples, the mass flow rate, the loss metric, and/or the quality of the cotton material represent cotton harvesting metrics associated with a cotton harvesting operation of the cotton harvester 100. In some examples, the vehicle sensors 124 can also measure and/or detect one or more vehicle metrics associated with the cotton harvester 100. For example, the vehicle metrics can include a ground speed of the cotton harvester 100, a position of a lever (e.g., a control lever) of the cotton harvester 100, a machine state of the cotton harvester 100, etc. The machine state can indicate whether the cotton harvester 100 is in a tether mode (e.g., in which the drums and/or spindles are rotated at relatively low speeds for inspection and/or maintenance), a stationary mode (e.g., in which the cotton harvester 100 is stationary and the rotational speeds of the drums and/or spindles are increased to, for example, remove and/or free an obstruction in the row units 116), and/or a normal operating mode (e.g. in which the cotton harvester 100 is performing a cotton harvesting operation and the drums and/or spindles are driven at rotational speeds proportional to the ground speed of the cotton harvester 100).

In the illustrated example of FIG. 2, the system control circuitry 122 is communicatively coupled to the vehicle sensors 124 to obtain vehicle sensor data therefrom, where the vehicle sensor data can include the cotton harvesting metric(s) and/or the vehicle metric(s) associated with the cotton harvester. In some examples, the system control circuitry 122 can select and/or adjust rotational speeds of the drums and/or the spindles of the row units 116 based on the vehicle sensor data to improve efficiency of a harvesting operation of the cotton harvester 100 by, for example, increasing the mass flow rate of the cotton material into the cotton harvester 100, reducing cotton loss, etc.

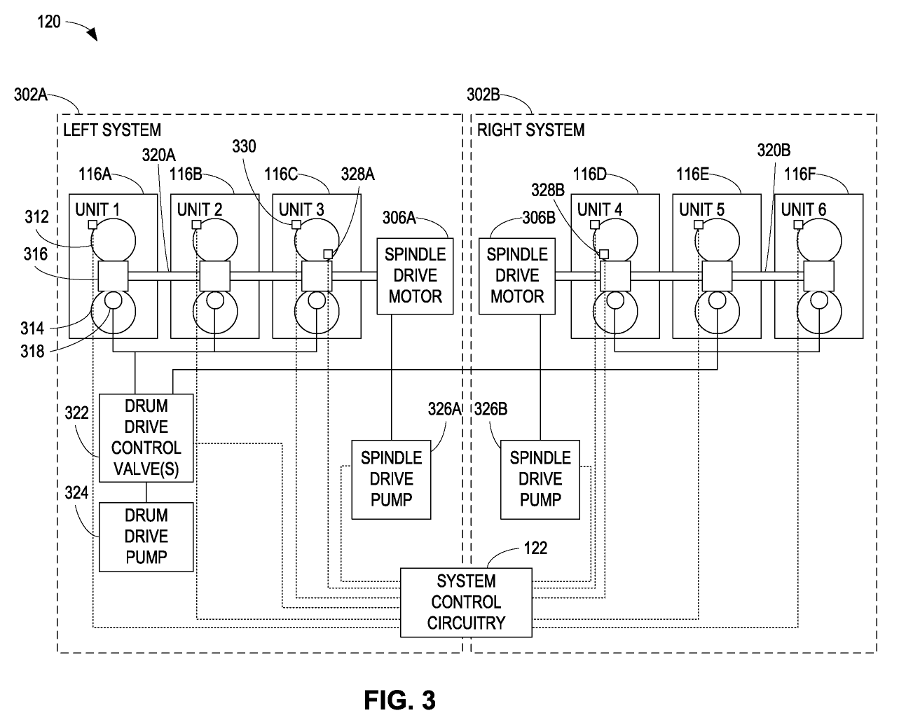

FIG. 3 is a schematic illustration of the example hydraulic system(s) 120 of FIG. 2. In the illustrated example of FIG. 3, the hydraulic system(s) 120 include a left system (e.g., a left hydraulic system) 302A operatively coupled to the first, second, and third row units 116A, 116B, 116C on a left hand side of the cotton harvester 100 of FIG. 3, and a right system (e.g., a right hydraulic system) 302B operatively coupled to the fourth, fifth, and sixth row units 116D, 116E, 116F on a right hand side of the cotton harvester 100 of FIG. 3. In this example, the right system 302B is substantially similar to (e.g., mirrors) the left system 302A. Thus, unless otherwise specified, descriptions of the left system 302A can likewise apply to the right system 302B.

In the illustrated example of FIG. 3, the first, second, third, fourth, fifth, and sixth row units 116A, 116B, 116C, 116D, 116E, 116F (collectively referred to herein as row units 116) include respective front drums 312 (one of which is labelled in FIG. 3) and rear drums 314 (one of which is labelled in FIG. 3) operatively coupled to gearboxes (e.g., variable transmission gearboxes, dual output gearboxes) 316 (one of which is labelled in FIG. 3) of the respective row units 116. The gearboxes 316 are further operatively coupled to spindles of the respective row units 116, where the spindles are coupled to and extend radially outward from respective ones of the front and rear drums 312, 314. In this example, the row units 116 include drum drive motors 318 (one of which is labelled in FIG. 3), where the drum drive motors 318 are operatively coupled to the front and rear drums 312, 314 of the respective row units 116 via the gearboxes 316. Further, the left system 302A includes a first spindle drive motor 306A operatively coupled to the gearboxes 316 of the first, second, and third row units 116A, 116B, 116C via a first input shaft (e.g., a first cross-shaft) 320A extending through the gearboxes 316 of the first, second, and third row units 116A, 116B, 116C. Similarly, the right system 302B includes a second spindle drive motor 306B operatively coupled to the gearboxes 316 of the fourth, fifth, and sixth row units 116D, 116E, 116F via a second input shaft (e.g., a second cross-shaft) 320B extending through the gearboxes 316 of the fourth, fifth, and sixth row units 116D, 116E, 116F.

In the illustrated example of FIG. 3, the hydraulic system 120 includes one or more drum drive control valves 322 operatively and/or fluidly coupled between a drum drive pump 324 and one(s) of the drum drive motors 318. For example, first one(s) of the drum drive control valves 322 are operatively and/or fluidly coupled to the drum drive motors 318 of the first, second, and third row units 116A, 116B, 116C, and second one(s) of the drum drive control valves 322 are operatively and/or fluidly coupled to the drum drive motors 318 of the fourth, fifth, and sixth row units 116D, 116E, 116F. Further, in the example of FIG. 3, a first spindle drive pump 326A is operatively and/or fluidly coupled to the first spindle drive motor 306A, and a second spindle drive pump 326B is operatively and/or fluidly coupled to the second spindle drive motor 306B.

In the illustrated example of FIG. 3, operation of the drum drive motors 318 and the spindle drive motors 306A, 306B drives rotation of the drums 312, 314 and the spindles of the respective row units 116. For example, operation of the spindle drive motors 306A, 306B drives rotation of the respective input shafts 320A, 320B, where the input shafts 320A, 320B are operatively coupled to the spindles via driveshafts included in the gearboxes 316 of the respective row units 116. In some such examples, rotational speeds and rotational directions of the spindles are based on rotational speeds and rotational directions of the corresponding spindle drive motors 306A, 306B. Stated differently, rotation of the spindles is controlled based on first inputs from the corresponding spindle drive motors 306A, 306B.

Further, the front and rear drums 312, 314 are operatively coupled, via the respective gearboxes 316, to the respective drum drive motors 318 and to the respective input shafts 320A, 320B (and, thus, to the spindle drive motors 306A, 306B). For example, the gearboxes 316 can include planetary gear systems to transmit power from the drum drive motors 318 and the input shafts 320 to the drums 312, 314, where sun gears (e.g., spindle drive gears) of the planetary gear systems are operatively coupled to (e.g., driven by) the input shafts 320A, 320B, and ring gears (e.g., drum drive gears) of the planetary gear systems are operatively coupled to (e.g., driven by) the drum drive motors 318. In such examples, rotational speeds and rotational directions of the drums 312, 314 are based on ratios between first rotational speeds (and/or rotational directions) of the sun gears and second rotational speeds of the ring gears. As a result, rotation of the front and rear drums 312, 314 is controlled based on the first inputs from the corresponding spindle drive motors 306A, 306B and second inputs from the corresponding drum drive motors 318.

In the illustrated example of FIG. 3, the left system 302A includes a first spindle drive sensor 328A, and the right system 302B includes a second spindle drive sensor 328B (where the first spindle drive sensor 328A and the second spindle drive sensor 328B are collectively referred to herein as spindle drive sensors 328). In some examples, the spindle drive sensors 328 measure and/or detect first rotational speeds of the driveshafts and/or the sun gears of the row units 116 in the respective left and right systems 302A, 302B. In some examples, spindle speeds (e.g., spindle rotational speeds) of the spindles can be calculated based on the first rotational speeds of the driveshafts and/or the sun gears.

In some examples, because the spindle speeds are based on (e.g., proportional to, mechanically linked to) rotational speeds of the corresponding input shafts 320A, 320B, the spindle speeds across the first, second, and third row units 116A, 116B, 116C in the left system 302A are substantially the same, and the spindle speeds across the fourth, fifth, and sixth row units 116D, 116E, 116F in the right system 302B are substantially the same. As a result, one sensor (e.g., the first spindle drive sensor 328A) can be implemented in the left system 302A to determine the spindle speeds across the first, second, and third row units 116A, 116B, 116C, and one sensor (e.g., the second spindle drive sensor 328B) can be implemented in the right system 302B to determine the spindle speeds across the fourth, fifth, and sixth row units 116D, 116E, 116F. In this example, the first spindle drive sensor 328A is implemented in and/or operatively coupled to the third row unit 116C, and the second spindle drive sensor 328B is implemented in and/or operatively coupled to the fourth row unit 116D. In some examples, the first spindle drive sensor 328A can be implemented in the first row unit 116A or the second row unit 116B (e.g., instead of in the third row unit 116C), and the second spindle drive sensor 328B can be implemented in the fifth row unit 116E or the sixth row unit 116F (e.g., instead of in the fourth row unit 116D).

In the illustrated example of FIG. 3, drum drive sensors 330 (one of which is labelled in FIG. 3) are implemented in respective row units 116. In some examples, the drum drive sensors 330 measure and/or detect second rotational speeds of the ring gears of the respective row units 116, where drum speeds (e.g., drum rotational speeds) of the front drums 312 and the rear drums 314 can be calculated based on the second rotational speeds of the ring gears and the first rotational speeds of the sun gears of the respective row units 116.

In some examples, rotational speeds and rotational directions of the spindle drive motors 306A, 306B and, thus, of the corresponding spindles and drums 312, 314 are based on a flow rate and a flow direction of fluid (e.g., hydraulic fluid) from the spindle drive pumps 326A, 326B to the corresponding spindle drive motors 306A, 306B. Further, rotational speeds of the drum drive motors 318 and, thus, of the corresponding drums 312, 314 are based on a flow rate of fluid from the drum drive control valves 322 to the corresponding drum drive motors 318. In some examples, positions of the drum drive control valves 322 can be adjusted and/or controlled (e.g., from an open position to a closed position, from a closed position to an open position, to an intermediate position between the open and closed positions, etc.) to control fluid flow from the drum drive pump 324 to the drum drive motors 318 (e.g., to adjust the rotational speeds and/or rotational directions of the drums 312, 314).

In the illustrated example of FIG. 3, the system control circuitry 122 is communicatively and/or operatively coupled to the drum drive control valves 322, the spindle drive pumps 326A, 326B, the spindle drive sensors 328, and the drum drive sensors 330. In some examples, the system control circuitry 122 can obtain sensor data from the spindle drive sensors 328 and/or the drum drive sensors 330, where the sensor data can be used to determine and/or derive rotational speeds (e.g., measured and/or calculated rotational speeds) of the spindle drive motor(s) 306A, 306B, the drum drive motors 318, the front drums 312, the rear drums 314, and/or the spindles of the respective row units 116. In some examples, based on the calculated rotational speeds and corresponding target rotational speeds for the drums 312, 314 and the spindle drive motor(s) 306A, 306B, the system control circuitry 122 can generate control signals to control and/or adjust one or more of the drum drive control valves 322 and/or the spindle drive pumps 326A, 326B. For example, the system control circuitry 122 can control, via the control signals, fluid flow from the spindle drive pumps 326A, 326B and/or the drum drive control valves 322 to control rotational speeds and/or rotational directions of the spindle drive motor(s) 306A, 306B and/or the drum drive motor(s) 318.

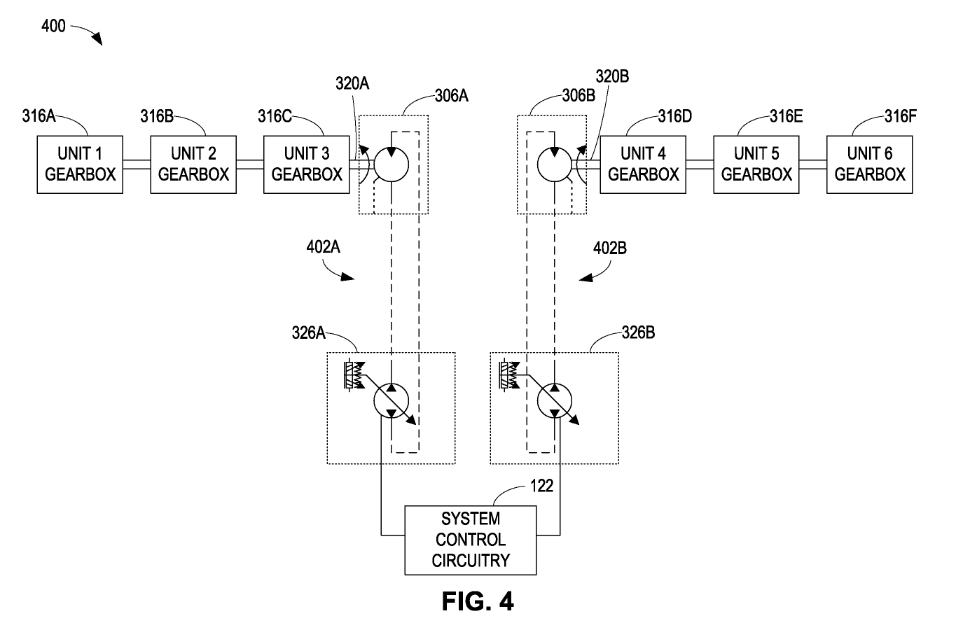

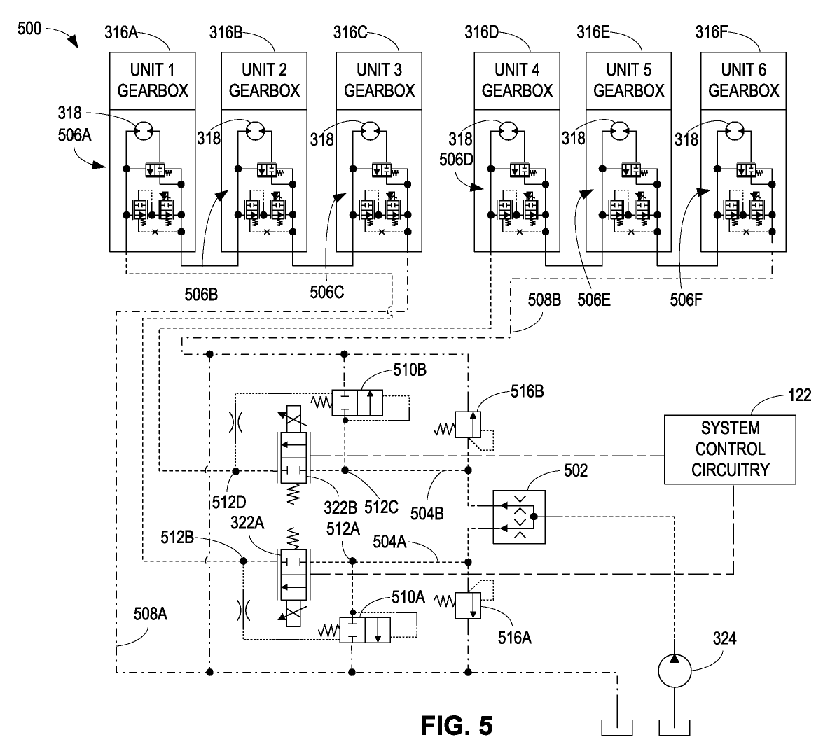

In the illustrated example of FIG. 3, the spindle drive pumps 326A, 326B, the spindle drive motors 306A, 306B, and the input shafts 320A, 320B correspond to a spindle drive system (e.g., a spindle drive circuit) of the hydraulic system 120. Further, the drum drive pump 324, the drum drive control valves 322, and the drum drive motors 318 correspond to a drum drive system (e.g., a drum drive circuit) of the hydraulic system 120. The spindle drive system and the drum drive system are described further in detail below in connection with FIGS. 4 and 5, respectively.

FIG. 4 is a schematic illustration of an example spindle drive system 400 of the example hydraulic system 120 of FIG. 3. In the illustrated example of FIG. 4, the spindle drive system 400 includes the first spindle drive pump 326A fluidly and/or operatively coupled to the first spindle drive motor 306A via a first hydraulic loop 402A, and further includes the second spindle drive pump 326B fluidly and/or operatively coupled to the second spindle drive motor 306B via a second hydraulic loop 402B. In this example, the spindle drive pumps 326A, 326B are variable displacement pumps, where an amount of fluid pumped by the spindle drive pumps 326A, 326B (e.g., a pump rate of the spindle drive pumps 326A, 326B) can be varied during operation of the spindle drive pumps 326A, 326B. In some examples, the system control circuitry 122 can control, via one or more control signals, displacement of the spindle drive pumps 326A, 326B. In such examples, flow rates of fluid from the spindle drive pumps 326A, 326B are based on the displacement. Additionally or alternatively, the system control circuitry 122 can control, via the control signals, directions of flow through the spindle drive pumps 326A, 326B. For example, the system control circuitry 122 can cause the spindle drive pumps 326A, 326B to direct fluid through the respective hydraulic loops 402A, 402B in a clockwise direction or in a counterclockwise direction in FIG. 4.

In the illustrated example of FIG. 4, as a result of the system control circuitry 122 causing the fluid to flow through the hydraulic loops 402A, 402B in a first direction (e.g., clockwise or counterclockwise in FIG. 4), the fluid flow in the hydraulic loops 402A, 402B drives operation of the respective spindle drive motors 306A, 306B and, thus, of the respective input shafts 320A, 320B in a first rotational direction. Conversely, as a result of the system control circuitry 122 causing the fluid to flow through the hydraulic loops 402A, 402B in a second direction (e.g., clockwise or counterclockwise in FIG. 4) opposite the first direction, the fluid flow in the hydraulic loops 402A, 402B drives operation of the respective spindle drive motors 306A, 306B and, thus, of the respective input shafts 320A, 320B in a second rotational direction (e.g., opposite the first rotational direction). In some examples, the rotational speeds of the spindle drive motors 306A, 306B and the input shafts 320A, 320B are based on a flow rate of the fluid in the respective hydraulic loops 402A, 402B. In this example, the spindle drive motors 306A, 306B are fixed displacement motors. In some examples, one or more different types of motors can be used for the spindle drive motors 306A, 306B.

In the illustrated example of FIG. 4, the first input shaft 320A is operatively coupled to first, second, and third gearboxes 316A, 316B, 316C corresponding to the first, second, and third row units 116A, 116B, 116C of FIG. 3. Further, the second input shaft 320B is operatively coupled to fourth, fifth, and sixth gearboxes 316D, 316E, 316F corresponding to the fourth, fifth, and sixth row units 116D, 116E, 116F of FIG. 3. The first input shaft 320A can drive rotation of the spindles of the first, second, and third row units 116A, 116B, 116C at substantially the same speeds, and the second input shaft 320B can drive rotation of the spindles of the fourth, fifth, and sixth row units 116D, 116E, 116F at substantially the same speeds.

FIG. 5 is a schematic illustration of an example drum drive system 500 of the hydraulic system 120 of FIG. 3. In the illustrated example of FIG. 5, the drum drive system 500 includes a first drum drive control valve 322A and a second drum drive control valve 322B fluidly coupled to the drum drive pump 324 via a flow divider 502. Further, the system control circuitry 122 is communicatively and/or operatively coupled to the drum drive control valves 322A, 322B. In the illustrated example, the first drum drive control valve 322A is implemented on a first supply line 504A from the flow divider 502 to a first auxiliary loop 506A, and the second drum drive control valve 322B is implemented on a second supply line 504B from the flow divider 502 to a fourth auxiliary loop 506D. The first auxiliary loop 506A is further fluidly coupled to a second auxiliary loop 506B, the second auxiliary loop 506B is fluidly coupled to a third auxiliary loop 506C, and the third auxiliary loop 506C is fluidly coupled to a first return line 508A. Further, the fourth auxiliary loop 506D is fluidly coupled to a fifth auxiliary loop 506E, the fifth auxiliary loop 506E is fluidly coupled to a sixth auxiliary loop 506F, and the sixth auxiliary loop 506F is fluidly coupled to a second return line 508B.

In the illustrated example of FIG. 5, the auxiliary loops 506A, 506B, 506C, 506D, 506E, 506F (collectively referred to herein as auxiliary loops 506) are fluidly and/or operatively coupled to respective ones of the drum drive motors 318 and, thus, to the respective gearboxes 316 (e.g., including a first gearbox 316A, a second gearbox 316B, a third gearbox 316C, a fourth gearbox 316D, a fifth gearbox 316E, a sixth gearbox 316F). Further, a first pressure compensator (e.g., a first pressure compensator valve) 510A is fluidly coupled to the first supply line 504A at a first location 512A upstream of the first drum drive control valve 322A and at a second location 512B downstream of the first drum drive control valve 322A, and is further fluidly coupled to the first return line 508A. A second pressure compensator (e.g., a second pressure compensator valve) 510B is fluidly coupled to the second supply line 504B at a third location 512C upstream of the second drum drive control valve 322B and at a fourth location 512D downstream of the second drum drive control valve 322B, and is further fluidly coupled to the second return line 508B. In the illustrated example of FIG. 5, a first relief valve 516A is fluidly coupled between the first return line 508A and the first supply line 504A (e.g., upstream of the first location 512A and the first drum drive control valve 322A), and a second relief valve 516B is fluidly coupled between the second return line 508B and the second supply line 504B (e.g., upstream of the third location 512C and the second drum drive control valve 322B).

In some examples, the first supply line 504A, the first drum drive control valve 322A, the first, second, and third auxiliary loops 506A, 506B, 506C, and the first return line 508A correspond to a first drum drive loop (e.g., a first drum drive hydraulic loop). Further, the second supply line 504B, the second drum drive control valve 322B, the fourth, fifth, and sixth auxiliary loops 506D, 506E, 506F, and the second return line 508B correspond to a second drum drive loop (e.g., a second drum drive hydraulic loop). In some examples, the first drum drive loop operates substantially similarly to the second drum drive loop. As such, description of the operation of the first drum drive loop applies equally to the second drum drive loop.

In operation, the system control circuitry 122 controls, via one or more control signals, positions of the drum drive control valves 322A, 322B to control a flow rate of fluid (e.g., hydraulic fluid) through the respective supply lines 504A, 504B from the drum drive pump 324 to the respective first auxiliary loop 506A and the fourth auxiliary loop 506D. For example, the drum drive control valves 322A, 322B can be solenoid valves, where positions of the drum drive control valves 322A, 322B are based on (e.g., proportional to) an amplitude of current of the control signal(s) to the respective drum drive control valves 322A, 322B. In some examples, the drum drive control valves 322A, 322B can move between a closed position, a fully open position, and one or more intermediate positions (e.g., between the closed position and the fully open position) based on the current amplitude(s) of the control signal(s). In some examples, moving the drum drive control valves 322A, 322B to (or toward) the closed position reduces the fluid flow rate through the drum drive control valves 322A, 322B, and moving the drum drive control valves 322A, 322B to (or toward) the fully open position increases the flow rate through the drum drive control valves 322A, 322B.

In some examples, the fluid from the drum drive control valves 322A, 322B flows through the respective supply lines 504A, 504B to and/or through the respective auxiliary loops 506, where the fluid flow through the auxiliary loops 506 drives operation of the respective drum drive motors 318. In such examples, rotational speeds of the drum drive motors 318 are based on the fluid flow rates through the respective auxiliary loops 506. In some examples, the system control circuitry 122 can control and/or adjust, via the control signal(s), positions of the drum drive control valves 322A, 322B to control the fluid flow rates through the respective drum drive motors 318 and, as a result, control the rotational speeds of the drum drive motors 318 and, thus, of the drums (e.g., the front drums 312 and/or the rear drums 314 of FIG. 3) operatively coupled to the drum drive motors 318.

In the illustrated example of FIG. 5, the first drum drive control valve 322A is used to control the fluid flow through the drum drive motors 318 of the first, second, and third auxiliary loops 506A, 506B, 506C, and the second drum drive control valve 322B is used to control the fluid flow (e.g., a flow rate of the fluid flow) through the drum drive motors 318 of the fourth, fifth, and sixth auxiliary loops 506D, 506E, 506F. In some examples, the second drum drive control valve 322B may be omitted and the third auxiliary loop 506C can be fluidly coupled to the fourth auxiliary loop 506D (e.g., instead of to the first return line 508A), such that the first drum drive control valve 322A can be used to control the fluid flow through a portion (e.g., all) of the auxiliary loops 506.

While fluid in the spindle drive system 400 of FIG. 4 can flow in two directions (e.g., clockwise and counterclockwise in FIG. 4) through the respective hydraulic loops 402A, 402B, fluid in the drum drive system 500 of FIG. 5 flows unidirectionally (e.g., in a single direction) from the drum drive control valves 322A, 322B to the respective auxiliary loops 506 and, thus, to the respective drum drive motors 318. As a result, the drum drive motors 318 rotate unidirectionally and at rotational speeds corresponding to the flow rate of the fluid to the respective drum drive motors 318. In some examples, the gearboxes 316 control rotational speeds of the respective drums 312, 314 of FIG. 3 based on relative rotation between the drum drive motors 318 and the respective spindle drive motors 306A, 306B of FIGS. 3 and 4. For example, the drums 312, 314 can be driven at a range of operational speeds by adjusting a first rotational speed of the respective spindle drive motor(s) 306A, 306B in either of two rotational directions but adjusting a second rotational speed of the respective drum drive motors 318 in only one of the rotational directions. As a result of the drum drive motors 318 being drivable in a single direction, examples described herein can reduce complexity of the drum drive system 500 (e.g., compared to a system in which the drum drive motors 318 are drivable in two directions).

In the illustrated example of FIG. 5, the pressure compensators 510A, 510B can be used to maintain a substantially constant pressure drop across the respective drum drive control valves 322A, 322B. For example, the first pressure compensator 510A can detect a first pressure drop between the first and second locations 512A, 512B of the first supply line 504A, and the second pressure compensator 510B can detect a second pressure drop between the third and fourth locations 512C, 512D of the second supply line 504B. In some examples, the pressure compensators 510A, 510B automatically switch between open and closed positions based on the detected pressure drops. For example, the pressure compensators 510A, 510B in the open position enable fluid flow from the respective first and third locations 512A, 512C to the respective return lines 508A, 508B, and the pressure compensators 510A, 510B in the closed position restrict fluid flow from the respective first and third locations 512A, 512C to the respective return lines 508A, 508B. As such, the pressure compensator 510A, 510B can maintain or relieve pressure from the respective first and third locations 512A, 512C to maintain substantially constant pressure drops across the drum drive control valves 322A, 322B. Further, in the illustrated example of FIG. 5, the relief valves 516A, 516B can automatically open when detected pressures in the respective supply lines 504A, 504B are above a threshold. In such examples, the relief valves 516A, 516B can relieve pressure in the respective supply lines 504A, 504B by redirecting a portion of the fluid from the supply lines 504A, 504B to the respective return lines 508A, 508B.

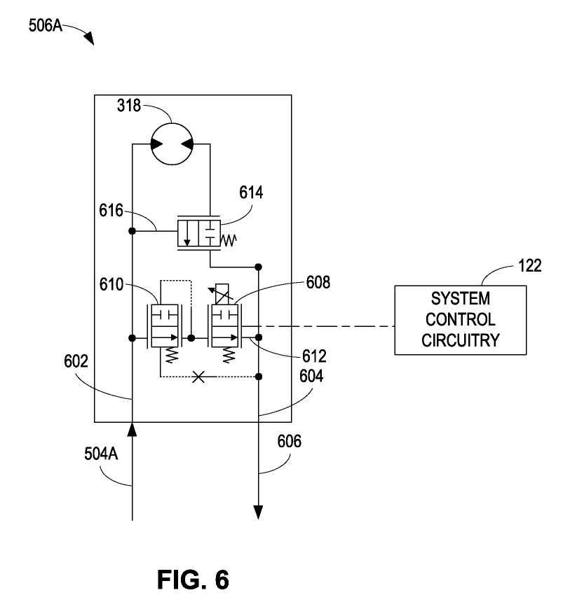

In some examples, fluid loss and/or leakage may occur in one or more locations of the drum drive system 500 of FIG. 5. For example, such loss and/or leakage may occur between the supply lines 504A, 504B and the respective return lines 508A, 508B and/or between corresponding ones of the auxiliary loops 506. As a result of such fluid loss, a flow rate of the fluid may decrease from upstream ones of the auxiliary loops 506 to downstream ones of the auxiliary loops 506 (e.g., from the first auxiliary loop 506A to the second auxiliary loop 506B, from the second auxiliary loop 506B to the third auxiliary loop 506C, from the fourth auxiliary loop 506D to the fifth auxiliary loop 506E, and/or from the fifth auxiliary loop 506E to the sixth auxiliary loop 506F). Variation in fluid flow between the auxiliary loops 506 may produce variation in rotational speeds across the corresponding drum drive motors 318 and, thus, across the corresponding drums 312, 314 of FIG. 3. In some examples, to maintain substantially equal rotational speeds across the drum drive motors 318, the auxiliary loops 506 can include one or more example bypass valves to adjust the fluid flow between adjacent ones of the auxiliary loops 506. Operation of the auxiliary loops 506 and the corresponding bypass valves is discussed further below in connection with FIG. 6.

FIG. 6 is an enlarged schematic illustration of the first auxiliary loop 506A of FIG. 5. While the first auxiliary loop 506A is described in FIG. 6, the description of the first auxiliary loop 506A can equally apply to any of the auxiliary loops 506 of FIG. 5. In the illustrated example of FIG. 6, the first auxiliary loop 506A includes an example inlet line 602 fluidly coupled between the supply line 504A and the drum drive motor 318 of the first auxiliary loop 506A, and further includes an example outlet line 604 fluidly coupled between the drum drive motor 318 and a connecting line 606 between the first auxiliary loop 506A and the second auxiliary loop 506B of FIG. 5. The first auxiliary loop 506A further includes an example bypass valve 608 and a third pressure compensator (e.g., a third pressure compensator valve) 610 implemented on a first bypass line 612 fluidly coupled between the inlet and outlet lines 602, 604, and an example meter out valve 614 implemented on a second bypass line 616 fluidly coupled between the inlet and outlet lines 602, 604.

In the illustrated example of FIG. 6, the system control circuitry 122 is communicatively and/or operatively coupled to the bypass valve 608 to control and/or adjust a position of the bypass valve 608 based on one or more control signals. For example, the bypass valve 608 can move to a closed position, a fully open position, or to an intermediate position between the closed and fully open positions based on the control signal(s). In some examples, the position of the bypass valve 608 is based on (e.g., proportional to) an amplitude of current (e.g., a current value) of the control signal(s). In some examples, the system control circuitry 122 adjusts the position of the bypass valve 608 to adjust an amount of fluid to bypass the drum drive motor 318 via the first bypass line 612 (e.g., to be redirected from the inlet line 602 to the outlet line 604 without flowing to or through the drum drive motor 318). In such examples, the bypass valve 608 can reduce fluid flow to the drum drive motor 318 and/or increase fluid flow to the connecting line 606 and, thus, to the second auxiliary loop 506B. As a result, the bypass valve 608 can compensate for fluid losses between the first and second auxiliary loops 506A, 506B to enable substantially equal flow rates to and, thus, substantially equal rotational speeds of the drum drive motors 318 of the first and second auxiliary loops 506A, 506B.

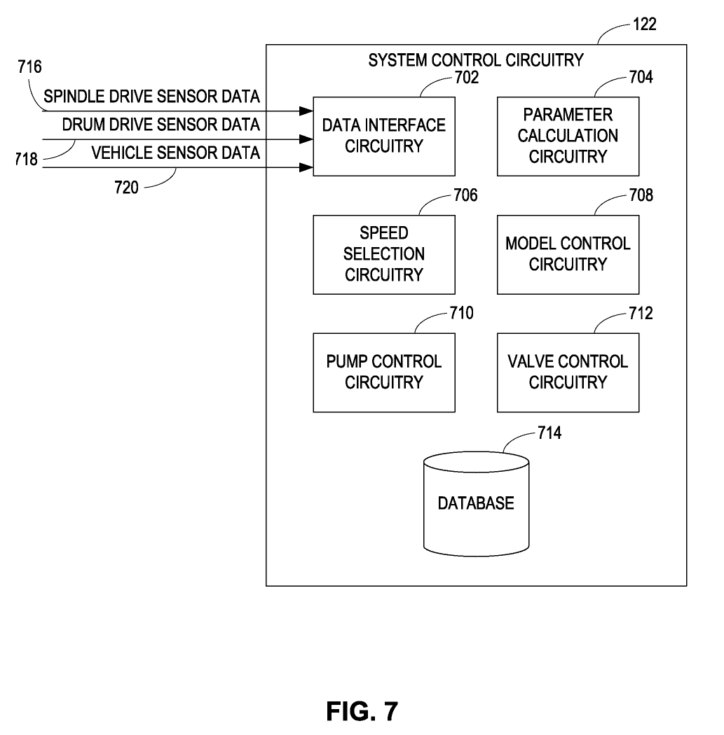

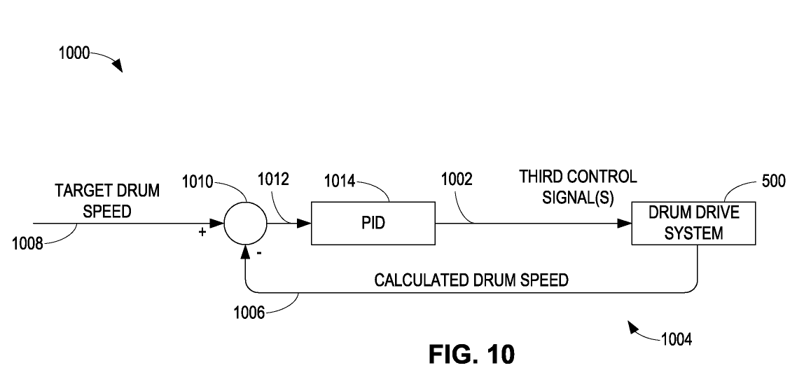

In some examples, the system control circuitry 122 selects the current amplitude(s) of the control signal(s) and, thus, the position of the bypass valve 608 based on a difference between a measured and/or calculated rotational speed and a target rotational speed for the drums 312, 314 associated with the first auxiliary loop 506A. Selection of the current amplitude(s) of the control signal(s) is discussed further below in connection with FIGS. 7 and 10.

FIG. 7 is a block diagram of an example implementation of the system control circuitry 122 of FIGS. 2- 6. The system control circuitry 122 of FIG. 7 may be instantiated (e.g., creating an instance of, bring into being for any length of time, materialize, implement, etc.) by programmable circuitry such as a Central Processor Unit (CPU) executing first instructions. Additionally or alternatively, the system control circuitry 122 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. Some or all of the circuitry of FIG. 7 may, thus, be instantiated at the same or different times. Some or all of the circuitry of FIG. 7 may be instantiated, for example, in one or more threads executing concurrently on hardware and/or in series on hardware. Moreover, in some examples, some or all of the circuitry of FIG. 7 may be implemented by microprocessor circuitry executing instructions and/or FPGA circuitry performing operations to implement one or more virtual machines and/or containers.

In the illustrated example of FIG. 7, the system control circuitry 122 includes example data interface circuitry 702, example parameter calculation circuitry 704, example speed selection circuitry 706, example model control circuitry 708, example pump control circuitry 710, example valve control circuitry 712, and an example database 714.

The data interface circuitry 702 of FIG. 7 accesses, obtains, and/or otherwise receives data to be utilized by the system control circuitry 122 for controlling drum speeds and spindle speeds of the cotton harvester 100 of FIG. 1. In this example, the data interface circuitry 702 obtains example spindle drive sensor data 716, example drum drive sensor data 718, and example vehicle sensor data 720. The data interface circuitry 702 obtains the spindle drive sensor data 716 from one(s) of the spindle drive sensors 328 of FIG. 3. In some examples, the spindle drive sensor data 716 represents first rotational speeds of sun gears and/or spindle drive gears included in the gearboxes 316 of the respective row units 116 of FIG. 3. Further, the data interface circuitry 702 obtains the drum drive sensor data 718 from one(s) of the drum drive sensors 330 of FIG. 3. In some examples, the drum drive sensor data 718 represents second rotational speeds of ring gears included in the respective gearboxes 316. The data interface circuitry 702 obtains the vehicle sensor data 720 from the vehicle sensor(s) 124 of FIG. 2. In some examples, the vehicle sensor data 720 can include cotton harvesting metric(s) such as a mass flow rate metric representative of a mass flow rate of cotton material into the cotton harvester 100, a loss metric representative of an amount of unharvested cotton material remaining in a field, a cotton quality metric representative of a quality of the cotton material harvested by the cotton harvester 100, etc. Additionally or alternatively, the vehicle sensor data 720 can include one or more vehicle metrics such as a ground speed of the cotton harvester 100, a lever position of a control lever of the cotton harvester 100 (e.g., where the control level enables manual adjustment of the drum speeds and/or spindle speeds), a machine state of the cotton harvester 100 (e.g., whether the cotton harvester 100 is in a tether mode, a stationary mode, a normal operating mode, etc.), oil temperature(s) at one or more locations of the cotton harvester 100, etc.

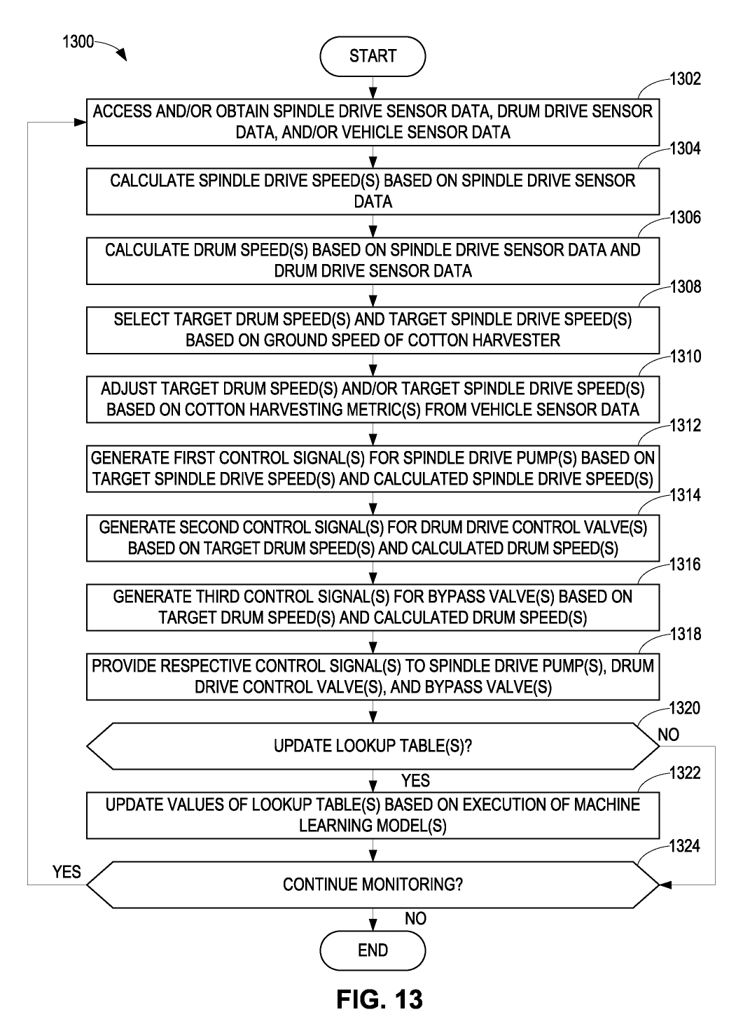

In some examples, the data interface circuitry 702 can access and/or obtain additional vehicle metric(s) associated with the cotton harvester 100, such as a unit type of the cotton harvester 100, age(s) of one or more components of the cotton harvester 100, etc. In some such examples, the data interface circuitry 702 can obtain the additional vehicle metric(s) based on user input to a user interface of the cotton harvester 100, and/or can obtain the additional vehicle metric(s) via one or more network communication(s), etc. In some examples, the additional vehicle metric(s) can be preloaded in the database 714. In some examples, the data interface circuitry 702 can provide the spindle drive sensor data 716, the drum drive sensor data 718, and/or the vehicle sensor data 720 to the database 714 for storage therein. In some examples, the data interface circuitry 702 is instantiated by programmable circuitry executing data interface circuitry instructions and/or configured to perform operations such as those represented by the flowchart(s) of FIG. 13.

The database 714 of FIG. 7 stores data utilized and/or obtained by the system control circuitry 122. For example, the database 714 can store the spindle drive sensor data 716, the drum drive sensor data 718, and/or the vehicle sensor data 720 obtained by the data interface circuitry 702. Additionally or alternatively, the database 714 can store the additional vehicle metrics preloaded in the system control circuitry 122 and/or input by a user (e.g., via a user interface of the cotton harvester 100). For example, the additional vehicle metric(s) can include a unit type of the cotton harvester 100, an age of the cotton harvester 100 and/or one or more components of the cotton harvester 100, dimension(s) associated with the component(s), etc. The database 714 of FIG. 7 is implemented by any memory, storage device and/or storage disc for storing data such as, for example, flash memory, magnetic media, optical media, solid state memory, hard drive(s), thumb drive(s), etc. Furthermore, the data stored in the database 714 may be in any data format such as, for example, binary data, comma delimited data, tab delimited data, structured query language (SQL) structures, etc. While, in the illustrated example, the database 714 is illustrated as a single device, the database 714 and/or any other data storage devices described herein may be implemented by any number and/or type(s) of memories.

The parameter calculation circuitry 704 can calculate and/or determine, based on data obtained and/or received by the data interface circuitry 702, one or more parameters associated with the cotton harvester 100. For example, the parameter calculation circuitry 704 can determine and/or calculate, based on the spindle drive sensor data 716, spindle speed(s) (e.g., spindle rotational speed(s)) for the spindles of the respective row units 116 of FIGS. 1, 2, and 3. Additionally or alternatively, the parameter calculation circuitry 704 can calculate, based on the spindle drive sensor data 716, spindle drive speed(s) of the respective spindle drive motors 306A, 306B of FIGS. 3 and 4. In some examples, the parameter calculation circuitry 704 can determine and/or calculate the spindle speed(s) and/or the spindle drive speed(s) based on rotational speed(s) of the sun gear(s) of the respective row units 116 (e.g., represented in the spindle drive sensor data 716), dimensions of one or more components of the row units 116, gear ratios associated with the one or more components, etc. In some examples, the calculated spindle speeds represent actual speeds at which the spindles are rotating at a given time, and the calculated spindle drive speeds represent actual speeds at which the respective spindle drive motors 306A, 306B are rotating at a given time. In some examples, the first spindle drive motor 306A rotates at a first spindle drive speed, and the second spindle drive motor 306B rotates at a second spindle drive speed, where the first spindle drive speed can be the same as or different from the second spindle drive speed.

Further, the parameter calculation circuitry 704 can determine, based on the spindle drive sensor data 716 and the drum drive sensor data 718, drum speeds (e.g., drum rotational speeds) for respective ones of the front and rear drums 312, 314 of FIG. 3. Further, the parameter calculation circuitry 704 can calculate, based on the spindle drive sensor data 716 and the drum drive sensor data 718, drum drive speed(s) of the respective drum drive motors 318 of FIG. 3. For example, the parameter calculation circuitry 704 can determine carrier speeds associated with the planetary gear systems of the respective gearboxes 316 based on differences (e.g., ratios) between the first rotational speeds of the sun gears (e.g., represented in the spindle drive sensor data 716) and the second rotational speeds of the corresponding ring gears (e.g., represented in the drum drive sensor data 718) of the planetary gear systems. In such examples, the parameter calculation circuitry 704 can calculate the drum speeds of the respective drums 312, 314 and/or the drum drive speeds of the respective drum drive motors 318 based on the carrier speeds associated with the respective gearboxes 316, dimensions of one or more components of the row units 116, gear ratios associated with the one or more components, etc. In some examples, the calculated drum speeds represent actual speeds at which the respective drums 312, 314 are rotating at a given time, and the drum drive speeds represent actual speeds at which the respective drum drive motors 318 are rotating at a given time. In some examples, the parameter calculation circuitry 704 provides the determined and/or calculated parameter(s) (e.g., the spindle speed(s), the spindle drive speed(s), the drum speed(s), and/or the drum drive speed(s)) to the database 714 for storage therein. In some examples, the parameter calculation circuitry 704 is instantiated by programmable circuitry executing parameter calculation circuitry instructions and/or configured to perform operations such as those represented by the flowchart(s) of FIG. 13.

The speed selection circuitry 706 selects, based on the vehicle sensor data 720, target speeds for the respective drums 312, 314 and/or spindles of the cotton harvester 100, the spindle drive motor(s) 306A, 306B, and/or the drum drive motor(s) 318 of FIG. 3. For example, the speed selection circuitry 706 selects target drum speeds (e.g., target drum rotational speeds) for the respective drums 312, 314 and/or target spindle speeds (e.g., target spindle rotational speeds) for the spindles based on a ground speed of the cotton harvester 100, where the ground speed is represented in the vehicle sensor data 720. In some such examples, the speed selection circuitry 706 selects the target drum speed(s) and/or the target spindle speed(s) based on lookup tables that relate the ground speed to the target drum and/or spindle speed(s). In some examples, the target drum and/or spindle speeds are proportional to the ground speed of the cotton harvester 100. Additionally or alternatively, the speed selection circuitry 706 selects the target spindle and/or drum speeds based on a lever position of a control lever of the cotton harvester 100, where the control lever enables an operator of the cotton harvester 100 to manually select the target spindle and/or drum speeds. In some examples, the speed selection circuitry 706 selects the target spindle and/or drum speeds based on the machine state of the cotton harvester 100 (e.g., based on whether the cotton harvester 100 is in a tether mode, a stationary mode, a normal operating mode, etc.). Further, the speed selection circuitry 706 can calculate target spindle drive speeds for the respective spindle drive motors 306A, 306B and target drum drive speeds for the respective drum drive motors 318 corresponding to the target spindle speeds and/or the target drum speeds.

In some examples, the speed selection circuitry 706 can adjust the target drum speed and/or the target spindle speed (and, thus, the target drum drive speed(s) and/or the target spindle drive speed(s)) to improve an operating efficiency associated with a cotton harvesting operation of the cotton harvester 100. For example, the speed selection circuitry 706 can monitor the vehicle sensor data 720 to determine one or more cotton harvesting metrics associated with an operation (e.g., a cotton harvesting operation) performed by the cotton harvester 100. In some examples, the cotton harvesting metrics can include one or more of a mass flow rate of cotton material into the cotton harvester 100, a loss metric representing an amount of unharvested cotton material in a field, a quality of the harvested cotton material, etc. In some examples, the speed selection circuitry 706 can adjust (e.g., increase or decrease) the target drum speed and/or the target spindle speed based on the cotton harvesting metric(s). For example, when the mass flow rate of the cotton material and/or the loss metric do not satisfy one or more performance thresholds, the speed selection circuitry 706 can increase the target drum speed(s) and/or the target spindle drive speed(s) to improve an efficiency (e.g., to increase the mass flow rate, to reduce loss, etc.) of the harvesting operation. In some examples, the speed selection circuitry 706 is instantiated by programmable circuitry executing speed selection circuitry instructions and/or configured to perform operations such as those represented by the flowchart(s) of FIG. 13.

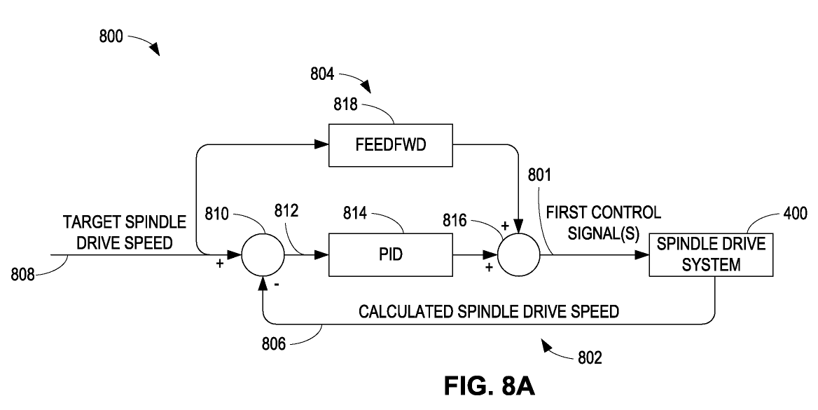

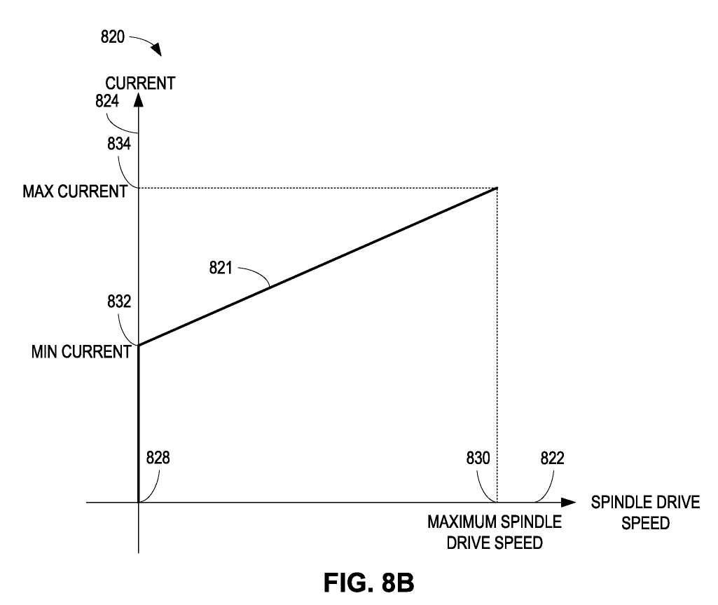

The pump control circuitry 710 of FIG. 7 generates and/or provides first control signal(s) (e.g., spindle drive pump control signal(s)) to respective one(s) of the spindle drive pumps 326A, 326B of FIGS. 3 and 4 to drive and/or control rotation of the corresponding spindles of the cotton harvester 100. For example, the pump control circuitry 710 can generate the first control signal(s) based on the calculated spindle drive speed(s) and the target spindle drive speed(s) for the respective spindle drive motors 306A, 306B of FIG. 3. In some examples, the pump control circuitry 710 generates the first control signal(s) based on an example spindle pump control loop (e.g., a spindle pump control algorithm) described further in detail below in connection with FIGS. 8A and 8B.

FIG. 8A is a schematic illustration of an example spindle pump control loop 800 implemented by the pump control circuitry 710 of FIG. 7. In the illustrated example of FIG. 8A, the pump control circuitry 710 implements and/or executes the spindle pump control loop 800 to generate first control signal(s) (e.g., spindle drive pump control signal(s)) 801 for controlling the first spindle drive pump 326A of FIGS. 3 and 4. While the spindle pump control loop 800 is described in connection with the first spindle drive pump 326A and/or the spindles of the left system 302A in this example, a second spindle pump control loop (e.g., substantially similar to the spindle pump control loop 800 of FIG. 8A) can be used to generate the first control signal(s) 801 for controlling the second spindle drive pump 326B and, thus, for driving the spindles of the right system 302B of FIG. 3.

In the illustrated example of FIG. 8A, the spindle pump control loop 800 corresponds to a proportional-integral-derivative (PID) control loop with an example feedback component 802 and an example feedforward component 804. In this example, the feedback component 802 includes an example calculated spindle drive speed 806 determined and/or calculated by the parameter calculation circuitry 704 of FIG. 7 for the first spindle drive motor 306A of FIG. 3. Further, an example target spindle drive speed 808 selected by the speed selection circuitry 706 of FIG. 7 for the first spindle drive motor 306A corresponds to a set point (e.g., a target value) for the spindle pump control loop 800. In the illustrated example of FIG. 8A, the pump control circuitry 710 determines, at a first calculation block 810, a difference (e.g., an error value) between the target spindle drive speed 808 and the calculated spindle drive speed 806.

In this example, the difference between the target spindle drive speed 808 and the calculated spindle drive speed 806 is provided as an example input 812 to an example PID block 814. At the PID block 814, the pump control circuitry 710 implements a PID controller to determine correction(s) to be applied to the first control signal(s) to reduce the error between the calculated and target spindle drive speeds 806, 808. For example, the pump control circuitry 710 determines gain(s) to be applied to the first control signal(s) to adjust a first flow rate from the first spindle drive pump 326A and, as a result, drive the first spindle drive motor 306A closer to the target spindle drive speed (e.g., to reduce the error between the target spindle drive speed 808 and the calculated spindle drive speed 806). In this example, an output of the PID block 814 is provided to a second calculation block 816. Further, in the illustrated example of FIG. 8A, the target spindle drive speed 808 is provided as input to an example feedforward block 818 of the feedforward component 804. At the feedforward block 818, the pump control circuitry 710 determines, based on the target spindle drive speed 808, an example current value (e.g., a current amplitude, a feedforward value) for the first control signal(s) 801 based on a first example feedforward model.

For example, FIG. 8B illustrates a first example graph 820 representative of the first feedforward model utilized by the pump control circuitry 710. The first feedforward model (e.g., represented by an example line 821 in FIG. 8B) relates target spindle drive speeds on a first axis (e.g., a horizontal axis, an X-axis) 822 of the first graph 820 to corresponding current values on a second axis (e.g., a vertical axis, a Y-axis) 824 of the first graph 820. Stated differently, the line 821 represents the resulting spindle drive speeds (e.g., along the first axis 822) that are expected to be achieved when the corresponding current values (e.g., along the second axis 824) are used for the first control signal(s) 801 to the first spindle drive pump 326A. In this example, the line 821 extends between a first threshold spindle drive speed (e.g., a minimum spindle speed, zero) 828 and a second threshold spindle drive speed (e.g., a maximum spindle speed) 830 on the first axis 822, and extends between a first threshold current value (e.g., a minimum current value) 832 and a second threshold current value (e.g., a maximum current value) 834 on the second axis 824. In this example, the first feedforward model is substantially linear (e.g., the current values represented by the line 821 increase proportionally with respect to the target spindle speed). In some examples, the first feedforward model may be different (e.g., the line 821 may be stepped, piecewise, curved, etc.).

In some examples, the first feedforward model can be generated (e.g., by the pump control circuitry 710) based on one or more values included in a first example lookup table. For example, the first lookup table relates spindle drive speeds of the first spindle drive motor 306A to corresponding first current values of the first control signal(s) 801 to the first spindle drive pump 326A. In some examples, the first lookup table can include values for the first threshold current value, the second threshold current value, the first threshold spindle drive speed, and the second threshold spindle drive speed. In some such examples, the pump control circuitry 710 generates the line 821 of FIG. 8B based on the first lookup table.

In some examples, the first lookup table is preloaded in the database 714 of FIG. 7 and accessible to the pump control circuitry 710. In some such examples, the first lookup table is based on an initial lookup table generated for and/or generic to a unit type of the cotton harvester 100 and/or the row units 116, and is further adjusted based on vehicle data (e.g., vehicle metric(s)) specific to the cotton harvester 100. For example, as discussed further in detail below in connection with the model control circuitry 708 of FIG. 7, one or more values of the first lookup table can be adjusted (e.g., using one or more machine learning models executed based on the vehicle data) to compensate for wear and/or age of one or more components of the cotton harvester 100, oil temperatures in the cotton harvester 100, etc.

In the illustrated example of FIG. 8B, the pump control circuitry 710 selects, based on the first feedforward model represented in the first graph 820, a first current value along the second axis 824 that corresponds to the target spindle drive speed 808 of FIG. 8A on the first axis 822. Returning to FIG. 8A, the pump control circuitry 710 provides the first current value as input to the second calculation block 816. At the second calculation block 816, the pump control circuitry 710 combines (e.g., aggregates) the inputs from the PID block 814 and the feedforward block 818 to generate and/or output the first control signal(s) 801.

In some examples, the pump control circuitry 710 is communicatively and/or operatively coupled to the spindle drive system 400 of FIG. 4 to provide the first control signal(s) 801 to the corresponding spindle drive pump 326A. As a result, the pump control circuitry 710 can control, via the first control signal(s) 801, a first fluid flow from the first spindle drive pump 326A to the first spindle drive motor 306A of FIGS. 3 and 4. In turn, the first fluid flow drives operation of the first spindle drive motor 306A such that the spindle drive speed of the first spindle drive motor 306A is substantially equal to or approaches the target spindle drive speed 808 over time. In some examples, the pump control circuitry 710 continually and/or periodically adjusts and/or outputs the first control signal(s) 801 during operation of the cotton harvester 100. In some examples, the pump control circuitry 710 is instantiated by programmable circuitry executing pump control circuitry instructions and/or configured to perform operations such as those represented by the flowchart(s) of FIG. 13.

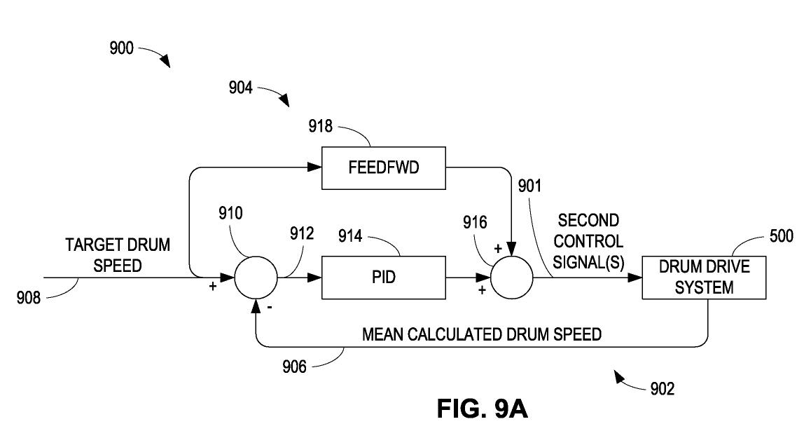

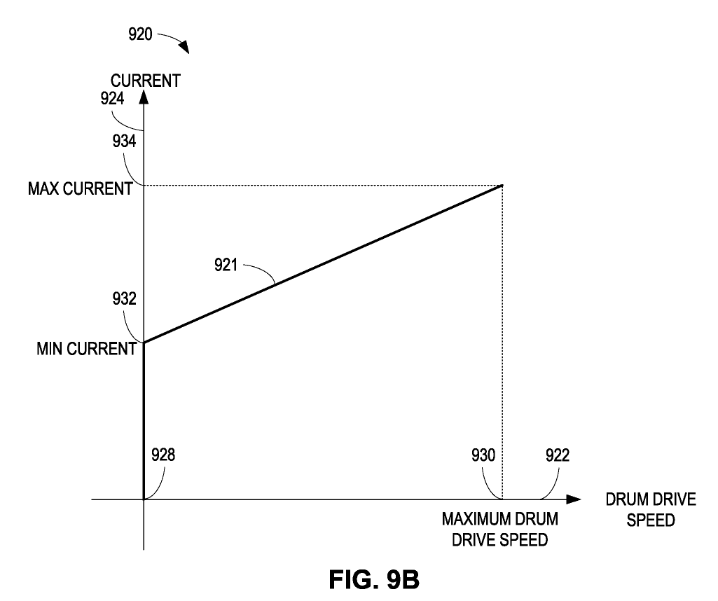

Returning to FIG. 7, the valve control circuitry 712 generates and/or provides second control signal(s) (e.g., drum drive valve control signal(s)) to respective one(s) of the drum drive control valves 322 of FIGS. 3 and 5 to control rotation of the corresponding drum drive motor(s) 318 of FIG. 3. For example, the valve control circuitry 712 can generate the second control signal(s) based on the calculated drum speed(s) and the target drum speed(s) for respective one(s) of the drums 312, 314 of FIGS. 3 and 5. In some examples, the valve control circuitry 712 generates the second control signal(s) based on an example drum valve control loop (e.g., a drum valve control algorithm) described further in detail below in connection with FIGS. 9A and 9B.

FIG. 9A is a schematic illustration of an example drum valve control loop 900 that may be implemented by the valve control circuitry 712 of FIG. 7. In the illustrated example of FIG. 9A, the valve control circuitry 712 implements and/or executes the drum valve control loop 900 to generate second control signal(s) (e.g., drum drive control valve control signal(s)) 901 for controlling the first drum drive control valve 322A of FIGS. 3 and 5. While the drum valve control loop 900 is described in connection with the first drum drive control valve 322A associated with the left system 302A in this example, a second drum valve control loop (e.g., substantially similar to the drum valve control loop 900 of FIG. 9A) can be used to generate the second control signal(s) 901 for controlling the second drum drive control valve 322B and, thus, driving the drums 312, 314 of the right system 302B of FIG. 3.

In the illustrated example of FIG. 9A, the drum valve control loop 900 (e.g., similar to the spindle pump control loop 800 of FIG. 8A) corresponds to a PID control loop with an example feedback component 902 and an example feedforward component 904. In this example, the feedback component 902 includes a mean calculated drum speed 906 determined and/or calculated by the parameter calculation circuitry 704 of FIG. 7. For example, the mean calculated drum speed 906 corresponds to a mean (e.g., an average) of a first calculated drum speed of the first row unit 116A, a second calculated drum speed of the second row unit 116B, and a third calculated drum speed of the third row unit 116C. Further, a target drum speed 908 selected by the speed selection circuitry 706 of FIG. 7 corresponds to a set point (e.g., a target value) for the drum valve control loop 900. In the illustrated example of FIG. 9A, the valve control circuitry 712 determines, at a first calculation block 910, a difference (e.g., an error value) between the target drum speed 908 and the mean calculated drum speed 906.

In this example, the difference between the target drum speed 908 and the mean calculated drum speed 906 is provided as an example input 912 to an example PID block 914. At the PID block 914, the valve control circuitry 712 implements a PID controller to determine correction(s) to be applied to the second control signal(s) 901 to reduce the error between the calculated and target drum speeds 906, 908. For example, the valve control circuitry 712 determines gain(s) to be applied to the second control signal(s) to drive the drums 312, 314 of the left system 302A closer to the target drum speed 908 (e.g., to reduce the error between the target drum speed 908 and the mean calculated drum speed 906). In this example, an output of the PID block 914 is provided to a second calculation block 916. Further, in the illustrated example of FIG. 9A, the target drum speed 908 is provided as input to an example feedforward block 918 of the feedforward component 904. At the feedforward block 918, the valve control circuitry 712 determines, based on the target drum speed 908, an example current value (e.g., a current amplitude, a feedforward value) for the second control signal(s) 901 based on a second example feedforward model.

For example, FIG. 9B illustrates a second example graph 920 representative of the second feedforward model utilized by the valve control circuitry 712. The second feedforward model (e.g., represented by an example line 921 in FIG. 9B) relates drum drive speeds of a corresponding one of the drum drive motors 318 on a first axis (e.g., a horizontal axis, an X-axis) 922 of the second graph 920 to corresponding current values on a second axis (e.g., a vertical axis, a Y-axis) 924 of the second graph 920. Stated differently, the line 921 represents the resulting drum drive speeds (e.g., along the first axis 922) that are expected to be achieved when the corresponding current values (e.g., along the second axis 924) are used for the second control signal(s) 901 to the drum drive control valve 322A. In this example, the line 921 extends between a first threshold drum drive speed (e.g., a minimum drum speed, zero) 928 and a second threshold drum drive speed (e.g., a maximum drum speed) 930 on the first axis 922, and extends between a first threshold current value (e.g., a minimum current value) 932 and a second threshold current value (e.g., a maximum current value) 934 on the second axis 924. In this example, the second feedforward model is substantially linear (e.g., the current values represented by the line 921 increase proportionally with respect to the target drum speed). In some examples, the second feedforward model may be different (e.g., the line 921 may be stepped, piecewise, curved, etc.).

In some examples, the second feedforward model can be generated (e.g., by the valve control circuitry 712) based on one or more values included in a second example lookup table. For example, the second lookup table relates drum drive speeds of a corresponding one of the drum drive motors 318 to corresponding second current values of the second control signal(s) 901 provided to the first spindle drive pump 326A. In some examples, the second lookup table can include values for the first threshold current value 932, the second threshold current value 934, the first threshold drum drive speed 928, and the second threshold drum drive speed 930. In some such examples, the valve control circuitry 712 generates the line 921 of FIG. 9B based on the second lookup table.

In some examples, the second lookup table is preloaded in the database 714 of FIG. 7 and accessible to the valve control circuitry 712. In some such examples, the second lookup table is based on an initial lookup table generated for and/or generic to a unit type of the cotton harvester 100 and/or the row units 116, and is further adjusted based on vehicle data (e.g., vehicle metric(s)) specific to the cotton harvester 100. For example, as discussed further in detail below in connection with the model control circuitry 708 of FIG. 7, one or more values of the second lookup table can be adjusted (e.g., using one or more machine learning models executed based on the vehicle data) to compensate for wear and/or age of one or more components of the cotton harvester 100, oil temperatures in the cotton harvester 100, etc.

Returning to FIG. 9A, the valve control circuitry 712 selects, based on the second feedforward model represented in the second graph 920 of FIG. 9B, a second current value corresponding to the target drum speed 908. For example, the valve control circuitry 712 calculates a target drum drive speed of a corresponding one of the drum drive motors 318 based on the target drum speed 908 of the corresponding drum(s) 312, 314, then selects the second current value along the second axis 924 of FIG. 9B that corresponds to the target drum drive speed along the first axis 922 of FIG. 9B.

In the illustrated example of FIG. 9A, the valve control circuitry 712 provides the selected second current value (e.g., output from the feedforward block 918) as input to the second calculation block 916. At the second calculation block 916, the valve control circuitry 712 combines (e.g., aggregates) the inputs from the PID block 914 and the feedforward block 918 to generate and/or output the second control signal(s) 901. In some examples, the valve control circuitry 712 is communicatively and/or operatively coupled to the drum drive system 500 of FIG. 5 to provide the second control signal(s) 901 to the corresponding drum drive control valve 322A. As a result, the valve control circuitry 712 can control, via the second control signal(s) 901, a second fluid flow from the first drum drive control valve 322A to the drum drive motors 318 of the first, second, and third row units 116A, 116B, 116C. The second fluid flow drives operation of corresponding one(s) of the drum drive motors 318 such that the drum drive speed of the drum drive motor(s) 318 is substantially equal to or approaches the target drum speed 908 over time. In turn, the drum drive motors 318 and the first spindle drive motor 306A can drive, via the corresponding gearboxes 316A, 316B, 316C and based on the first fluid flow from the first spindle drive pump 326A and the second fluid flow from the first drum drive control valve 322A, rotation of the drums 312, 314 of the corresponding row units 116A, 116B, 116C. In some examples, the valve control circuitry 712 continually and/or periodically adjusts and/or outputs the second control signal(s) 901 during operation of the cotton harvester 100.

In some examples, in addition to the second control signal(s) 901, the valve control circuitry 712 generates and/or provides third control signal(s) (e.g., bypass valve control signal(s)) to respective bypass valves 608 of the respective row units 116 of FIGS. 3 and 5. For example, the valve control circuitry 712 can generate the third control signal(s) based on the calculated drum speed(s) and the target drum speed(s) for respective one(s) of the drums 312, 314 of FIGS. 3 and 5. In some examples, the valve control circuitry 712 generates the third control signal(s) based on an example bypass valve control loop (e.g., a bypass valve control algorithm) described further in detail below in connection with FIG. 10.

FIG. 10 is a schematic illustration of an example bypass valve control loop 1000 that may be implemented by the valve control circuitry 712 of FIG. 7. In the illustrated example of FIG. 10, the valve control circuitry 712 implements and/or executes the bypass valve control loop 1000 to generate third control signal(s) (e.g., bypass valve control signal(s)) 1002 for controlling the respective bypass valve 608 of FIG. 6. While the bypass valve control loop 1000 is described in connection with the bypass valve 608 of the first row unit 116A in this example, one or more bypass valve control loops (e.g., substantially similar to the bypass valve control loop 1000 of FIG. 10) can be used to generate the third control signal(s) 1002 for respective bypass valve(s) 608 of remaining one(s) of the row units 116.

In the illustrated example of FIG. 10, the bypass valve control loop 1000 (e.g., similar to the spindle pump control loop 800 of FIG. 8A and/or the drum valve control loop 900 of FIG. 9A) corresponds to a proportional-integral-derivative (PID) control loop with an example feedback component 1004. Unlike the spindle pump control loop 800 of FIG. 8A and/or the drum valve control loop 900 of FIG. 9A, the bypass valve control loop 1000 of FIG. 10 does not include a feedforward component. In the illustrated example of FIG. 10, the feedback component 1004 includes a calculated drum speed 1006 determined and/or calculated by the parameter calculation circuitry 704 of FIG. 7, where the calculated drum speed 1006 corresponds to a rotational speed of the drums 312, 314 of the first row unit 116A. In this example, an example target drum speed 1008 (e.g., selected by the speed selection circuitry 706 of FIG. 7) corresponds to a target speed for the drums 312, 314 of the first row unit 116A and represents a set point (e.g., a target value) for the bypass valve control loop 1000. In the illustrated example of FIG. 10, the valve control circuitry 712 determines, at a first calculation block 1010, a difference (e.g., an error value) between the target drum speed 1008 and the calculated drum speed 1006.

In this example, the difference between the target drum speed 1008 and the calculated drum speed 1006 is provided as an example input 1012 to an example PID block 1014. At the PID block 1014, the valve control circuitry 712 implements a PID controller to determine correction(s) to be applied to the third control signal(s) 1002 to reduce the error between the calculated and target drum speeds 1006, 1008. For example, the valve control circuitry 712 determines gain(s) to be applied to the third control signal(s) 1002 to drive the drums 312, 314 of the first row unit 116A closer to the target drum speed 1008 (e.g., to reduce the error between the target drum speed 1008 and the calculated drum speed 1006). Based on an output of the PID block 1014, the valve control circuitry 712 generates and/or outputs the third control signal(s) 1002.

In some examples, the valve control circuitry 712 is communicatively and/or operatively coupled to the drum drive system 500 of FIG. 5 to provide the third control signal(s) 1002 to the bypass valve 608 of the first row unit 116A. As a result, the valve control circuitry 712 can control, via the third control signal(s) 1002, a position of the bypass valve 608 to control an amount of fluid to bypass the drum drive motor 318 of the first row unit 116A and flow to the second row unit 116B. As a result, the valve control circuitry 712 can adjust the fluid flow to and, thus, a rotational speed of the drum drive motor 318 of the first row unit 116A. In some examples, the valve control circuitry 712 continually and/or periodically adjusts and/or outputs the third control signal(s) 1002 during operation of the cotton harvester 100. In some examples, the valve control circuitry 712 is instantiated by programmable circuitry executing valve control circuitry instructions and/or configured to perform operations such as those represented by the flowchart(s) of FIG. 13.

Returning to FIG. 7, the model control circuitry 708 generates, trains, and/or executes one or more machine learning models to be utilized by the system control circuitry 122. For example, the machine learning model(s) may be used to update one or more values of one or more lookup tables used to generate the first feedforward model (e.g., represented by the first graph 820 of FIG. 8B) and/or the second feedforward model (e.g., represented by the second graph 920 of FIG. 9B). In some examples, the model control circuitry 708 executes the machine learning model(s) based on one or more vehicle metrics stored in the database 714 and/or represented in the vehicle sensor data 720. For example, the vehicle metrics can include oil temperature(s) at one or more locations of the cotton harvester 100, wear and/or age of one or more components of the cotton harvester 100, an age and/or a unit type of the cotton harvester 100, etc.

In some examples, based on a result of the execution of the machine learning model(s), the model control circuitry 708 can adjust the value(s) of the lookup table(s) (e.g., the first lookup table relating spindle drive speeds to corresponding first current values of the first control signal(s) 801 and/or the second lookup table relating drum drive speeds to corresponding second current values of the second control signal(s) 901). For example, the model control circuitry 708 can adjust, based on an output of the executed machine learning model(s), the first threshold current value 832, the second threshold current value 834, the first threshold spindle drive speed 828, and/or the second threshold spindle drive speed 830 included in the first lookup table and represented in the first graph 820 of FIG. 8B. Additionally or alternatively, based on the output of the executed machine learning model(s), the model control circuitry 708 can adjust the first threshold current value 932, the second threshold current value 934, the first threshold drum drive speed 928, and/or the second threshold drum drive speed 930 included in the second lookup table and represented in the second graph 920 of FIG. 9B.

In some examples, by adjusting the value(s) of the lookup table(s) based on the vehicle metric(s), the model control circuitry 708 can improve accuracy and/or reliability of the lookup table(s) with respect to current operating conditions of the cotton harvester 100. As a result, the adjusted lookup table(s) enable more precise and/or reliable control of the rotational speeds of the spindle drive motors 306A, 306B and/or the drum drive motors 318 (e.g., compared to when initial and/or unadjusted lookup table(s) generic to a unit type of the cotton harvester are used). In some examples, the model control circuitry 708 is instantiated by programmable circuitry executing model control circuitry instructions and/or configured to perform operations such as those represented by the flowchart(s) of FIG. 13.

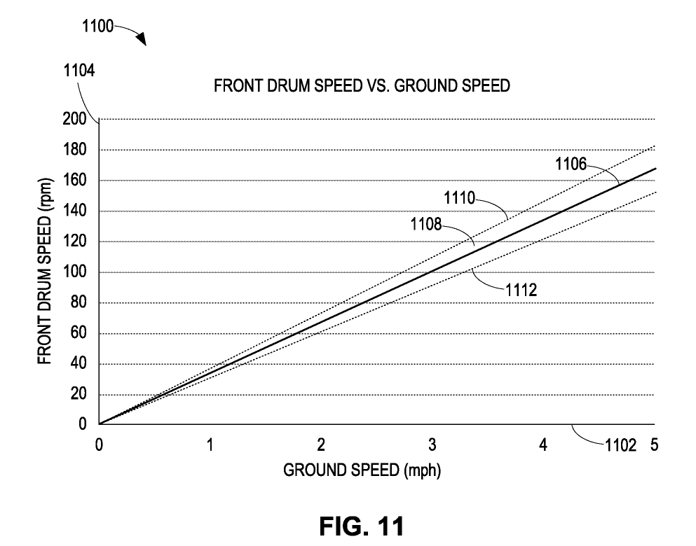

FIG. 11 illustrates a third example graph 1100 representative of example front drum speeds (e.g., rotational speeds of the front drum(s) 312 of the cotton harvester 100) relative to example ground speeds (e.g., travel speeds, vehicle speeds) of the cotton harvester 100 of FIG. 1. In the illustrated example of FIG. 11, the ground speeds (e.g., in miles per hour (mph)) are represented along a first axis (e.g., a horizontal axis) 1102 of the third graph 1100, and the front drum speeds (e.g., in revolutions per minute (rpm)) are represented along a second axis (e.g., a vertical axis) 1104. In this example, a first example line 1106 represents resulting front drum speeds of the front drums 312 along the second axis 1104 when the cotton harvester 100 is driven at the corresponding ground speeds along the first axis 1102. For example, the first line 1106 represents the front drum speeds that may be achieved at corresponding ground speeds using a known cotton harvester row unit (e.g., in which the front drum speed is directly proportional to the ground speed). While the relationship between the front drum speeds and the ground speeds is linear and/or proportional in this example, the relationship between the front drum speeds and the ground speeds can be nonlinear and/or non-proportional in some examples.

In the illustrated example of FIG. 11, an area 1108 between a first boundary line 1110 and a second boundary line 1112 represents a range of front drums speeds that may be achieved using examples described herein. For example, by utilizing the hydraulic system 120 and the gearboxes 316 of FIG. 3 to drive the corresponding front drums 312, the front drum speeds can be varied relative to a given ground speed of the cotton harvester 100. As a result, examples described herein can improve efficiency of a cotton harvesting operation of the cotton harvester 100 by, for example, increasing the front drum speeds relative to the ground speed to increase a flow rate of cotton material into the cotton harvester 100, reduce loss (e.g., reduce an amount of cotton material remaining in the field), etc.

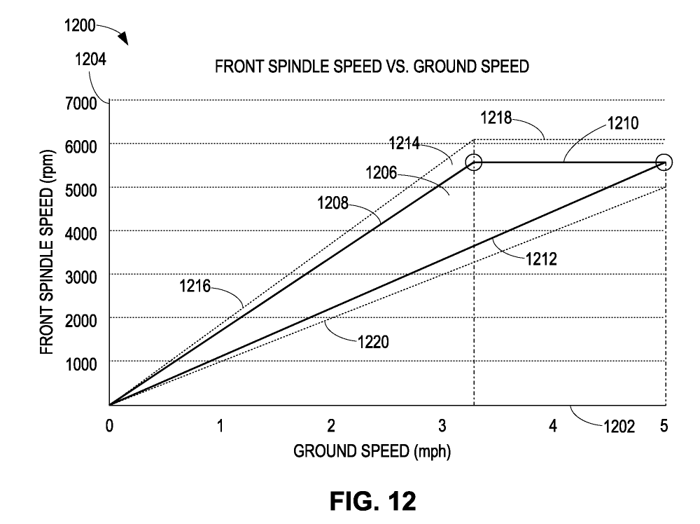

FIG. 12 illustrates a fourth example graph 1200 representative of example front spindle speeds (e.g., rotational speeds of spindles of the front drum(s) 312 of the cotton harvester 100) relative to example ground speeds (e.g., travel speeds, vehicle speeds) of the cotton harvester 100 of FIG. 1. In the illustrated example of FIG. 12, the ground speeds (e.g., in miles per hour (mph)) are represented along a first axis (e.g., a horizontal axis) 1202 of the fourth graph 1200, and the front spindle speeds (e.g., in revolutions per minute (rpm)) are represented along a second axis (e.g., a vertical axis) 1204. In this example, a first area 1206 defined by first boundary lines 1208, 1210, 1212 represents a first range of the front spindle speeds that may be achieved at corresponding ground speeds using a known cotton harvester row unit (e.g., in which the front drum speed is directly proportional to the ground speed). While the relationship between the front spindle speeds and the ground speeds is linear and/or proportional in this example, the relationship between the front spindle speeds and the ground speeds can be nonlinear and/or non-proportional in some examples.

In the illustrated example of FIG. 12, a second area 1214 between second boundary lines 1216, 1218, 1220 represents a second range of the front spindle speeds that can be achieved using examples described herein, where the second range of the front spindle speeds is greater than the first range of the front spindle speeds. In some examples, by utilizing the hydraulic system 120 and the gearboxes 316 of FIG. 3 to drive the spindles of the corresponding front drums 312, the front spindles speeds can be varied (e.g., relative to a given ground speed of the cotton harvester 100) across a greater range compared to when known spindle drive techniques are used. As a result, examples described herein can improve efficiency of a cotton harvesting operation of the cotton harvester 100.

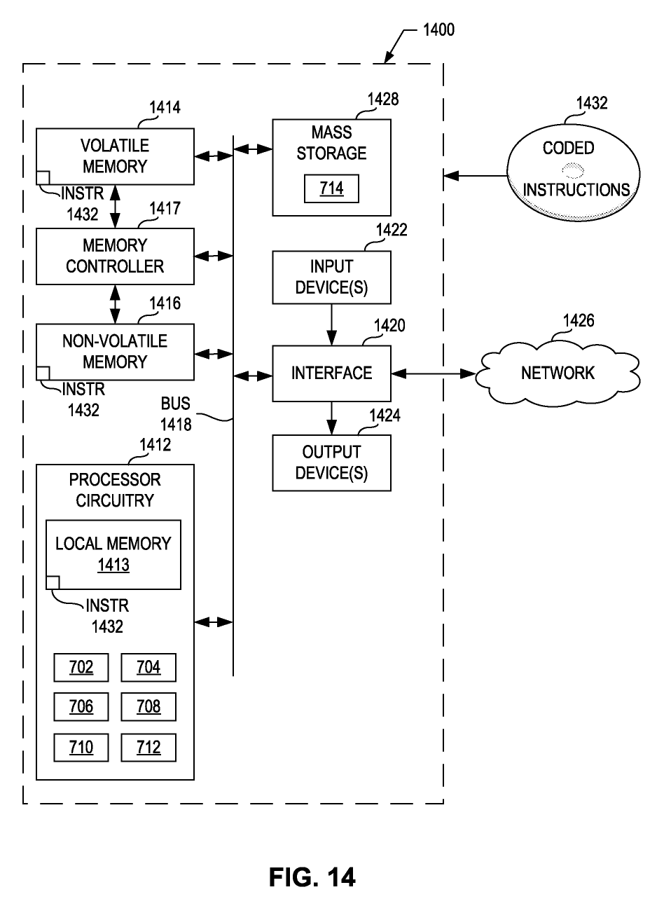

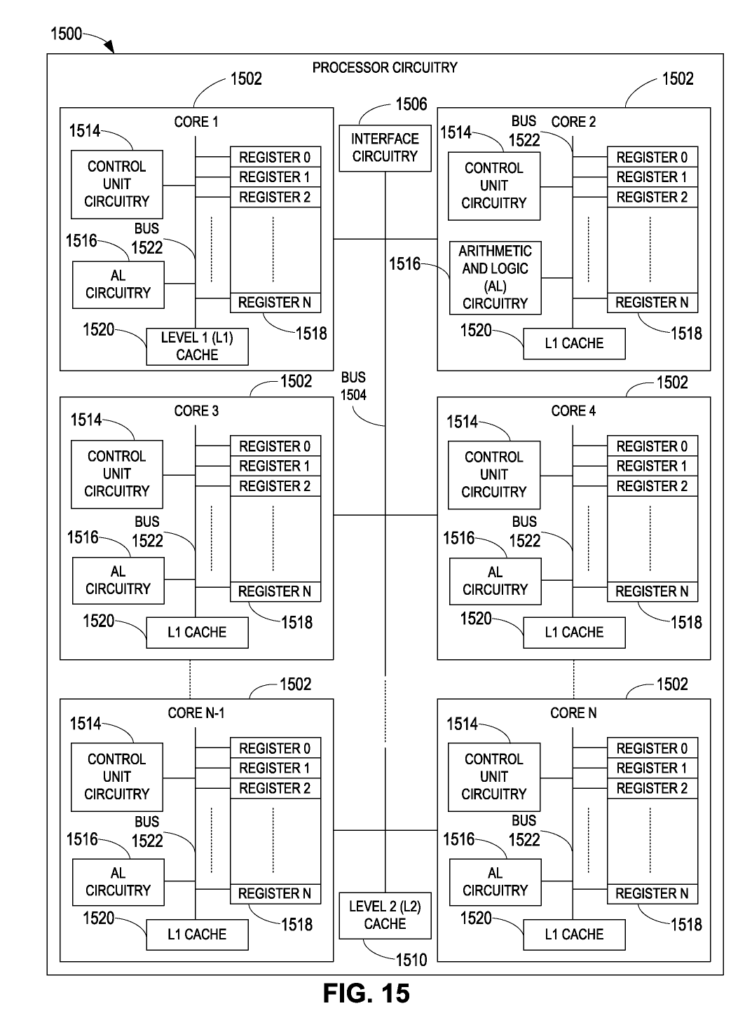

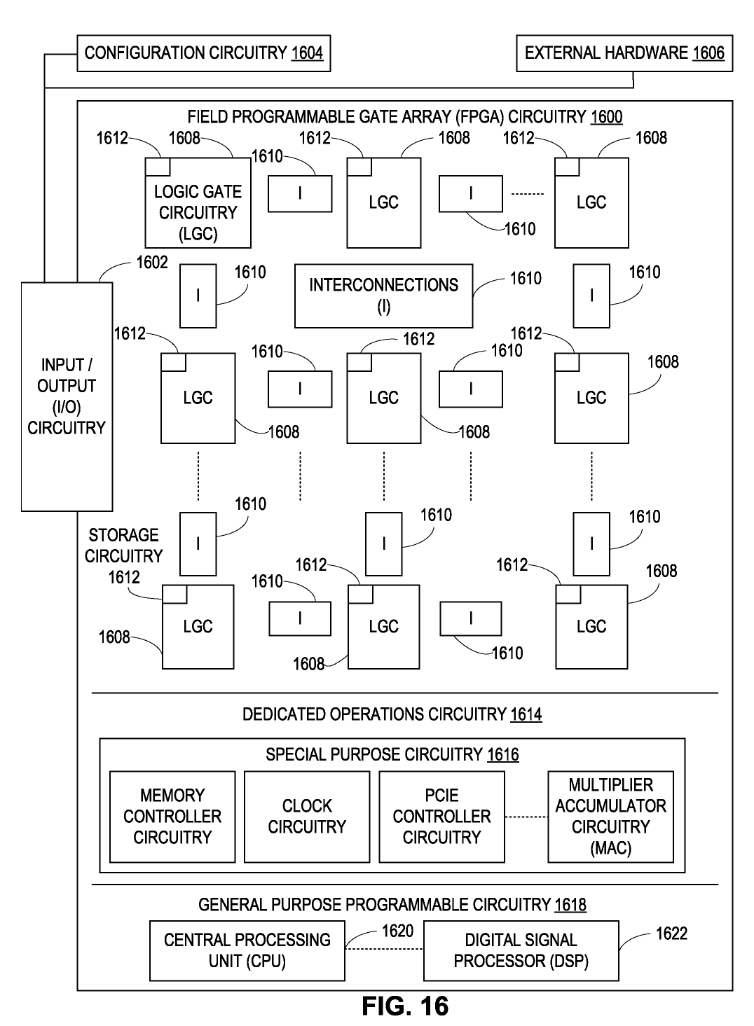

In some examples, the system control circuitry 122 includes means for obtaining data, means for calculating a parameter, means for selecting a speed, means for executing a model, means for controlling a pump, and means for controlling a valve. For example, the means for obtaining data may be implemented by the data interface circuitry 702, the means for calculating a parameter may be implemented by the parameter calculation circuitry 704, the means for selecting a speed may be implemented by the speed selection circuitry 706, the means for executing a model may be implemented by the model control circuitry 708, the means for controlling a pump may be implemented by the pump control circuitry 710, and the means for controlling a valve may be implemented by the valve control circuitry 712. In some examples, the data interface circuitry 702, the parameter calculation circuitry 704, the speed selection circuitry 706, the model control circuitry 708, the pump control circuitry 710, and/or the valve control circuitry 712 may be instantiated by programmable circuitry such as the example programmable circuitry 1412 of FIG. 14. For instance, the data interface circuitry 702, the parameter calculation circuitry 704, the speed selection circuitry 706, the model control circuitry 708, the pump control circuitry 710, and/or the valve control circuitry 712 may be instantiated by the example microprocessor 1500 of FIG. 15 executing machine executable instructions such as those implemented by at least blocks 1302, 1304, 1306, 1308, 1310, 1312, 1314, 1316, 1318, 1320, 1322, 1324 of FIG. 13. In some examples, the data interface circuitry 702, the parameter calculation circuitry 704, the speed selection circuitry 706, the model control circuitry 708, the pump control circuitry 710, and/or the valve control circuitry 712 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the data interface circuitry 702, the parameter calculation circuitry 704, the speed selection circuitry 706, the model control circuitry 708, the pump control circuitry 710, and/or the valve control circuitry 712 may be instantiated by any other combination of hardware, software, and/or firmware. For example, the data interface circuitry 702, the parameter calculation circuitry 704, the speed selection circuitry 706, the model control circuitry 708, the pump control circuitry 710, and/or the valve control circuitry 712 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the system control circuitry 122 of FIGS. 2- 6 is illustrated in FIG. 7, one or more of the elements, processes, and/or devices illustrated in FIG. 7 may be combined, divided, re-arranged, omitted, eliminated, and/or implemented in any other way. Further, the data interface circuitry 702, the parameter calculation circuitry 704, the speed selection circuitry 706, the model control circuitry 708, the pump control circuitry 710, the valve control circuitry 712, the database 714, and/or, more generally, the example system control circuitry 122 of FIG. 7, may be implemented by hardware alone or by hardware in combination with software and/or firmware. Thus, for example, any of the data interface circuitry 702, the parameter calculation circuitry 704, the speed selection circuitry 706, the model control circuitry 708, the pump control circuitry 710, the valve control circuitry 712, the database 714, and/or, more generally, the example system control circuitry 122, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example system control circuitry 122 of FIG. 7 may include one or more elements, processes, and/or devices in addition to, or instead of, those illustrated in FIG. 7, and/or may include more than one of any or all of the illustrated elements, processes and devices.

Flowchart(s) representative of example machine readable instructions, which may be executed by programmable circuitry to implement and/or instantiate the system control circuitry 122 of FIG. 7 and/or representative of example operations which may be performed by programmable circuitry to implement and/or instantiate the system control circuitry 122 of FIG. 7, are shown in FIG. 13. The machine readable instructions may be one or more executable programs or portion(s) of one or more executable programs for execution by programmable circuitry such as the programmable circuitry 1412 shown in the example processor platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIG. 13, many other methods of implementing the example system control circuitry 122 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine-readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine readable instructions and/or the corresponding program(s) can be executed in whole or in part. Thus, machine-readable, computer readable and/or machine-readable media, as used herein, may include instructions and/or program(s) regardless of the particular format or state of the machine readable instructions and/or program(s).

The machine-readable instructions described herein can be represented by any past, present, or future instruction language, scripting language, programming language, etc. For example, the machine-readable instructions may be represented using any of the following languages: C, C++, Java, C#, Perl, Python, JavaScript, HyperText Markup Language (HTML), Structured Query Language (SQL), Swift, etc.

As mentioned above, the example operations of FIG. 13 may be implemented using executable instructions (e.g., computer readable and/or machine-readable instructions) stored on one or more non-transitory computer readable and/or machine-readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/ or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

FIG. 13 is a flowchart representative of example machine readable instructions and/or example operations 1300 that may be executed, instantiated, and/or performed by the system control circuitry 122 of FIGS. 2-7. The example machine-readable instructions and/or the example operations 1300 of FIG. 13 begin at block 1302, at which the system control circuitry 122 accesses and/or obtains the spindle drive sensor data 716, the drum drive sensor data 718, and/or the vehicle sensor data 720 of FIG. 7. For example, the example data interface circuitry 702 of FIG. 7 obtains the spindle drive sensor data 716 from the spindle drive sensor(s) 328A, 328B of FIG. 3, obtains the drum drive sensor data 718 from the drum drive sensor(s) 330 of FIG. 3, and/or obtains the vehicle sensor data 720 from one or more of the vehicle sensors 124 of FIG. 2. In some examples, the spindle drive sensor data 716 represents first rotational speed(s) of first gear(s) (e.g., sun gear(s)) of the respective gearboxes 316 of FIGS. 2 and 3, and the drum drive sensor data 718 represents second rotational speed(s) of second gear(s) (e.g., ring gear(s)) of the respective gearboxes 316. In some examples, the vehicle sensor data 720 can include cotton harvesting metric(s) such as a mass flow rate of cotton material into the cotton harvester 100, an amount of unharvested cotton material remaining in a field, a quality of the cotton material harvested by the cotton harvester 100, etc. Additionally or alternatively, the vehicle sensor data 720 can include one or more vehicle metrics such as a ground speed of the cotton harvester 100, a lever position of a control lever of the cotton harvester 100, a machine state of the cotton harvester 100, oil temperature(s) at one or more locations of the cotton harvester 100, etc.

At block 1304, the example system control circuitry 122 calculates spindle drive speed(s) based on the spindle drive sensor data 716. For example, the example parameter calculation circuitry 704 of FIG. 7 calculates, based on the first rotational speed(s) of the sun gear(s) of the respective gearboxes 316, the spindle drive speed(s) of the respective spindle drive motor(s) 306A, 306B operatively coupled to the gearboxes 316. In some examples, the calculated spindle drive speed(s) represent actual (e.g., ground truth, current) spindle drive speed(s) of the respective spindle drive motor(s) 306A, 306B at a corresponding time.

At block 1306, the example system control circuitry 122 calculates, based on the spindle drive sensor data 716 and the drum drive sensor data 718, drum speed(s) of the respective drum(s) 312, 314 of the cotton harvester 100. For example, the parameter calculation circuitry 704 can calculate the drum speed(s) based on difference(s) between the first rotational speed(s) of the sun gear(s) of respective gearboxes 316 and the second rotational speed(s) of the corresponding ring gear(s) of the respective gearboxes 316. In some examples, the calculated drum speed(s) represent actual (e.g., ground truth, current) drum speed(s) of the respective drum(s) 312, 314 at a corresponding time.

At block 1308, the example system control circuitry 122 selects target drum speed(s) and target spindle drive speed(s) based on a ground speed of the cotton harvester 100. For example, based on a current ground speed of the cotton harvester 100, the example speed selection circuitry 706 of FIG. 7 selects and/or calculates the target drum speed and the target spindle drive speed. In some examples, the target drum speed(s) and/or the target spindle drive speed(s) are proportional to the ground speed.

At block 1310, the example system control circuitry 122 adjusts the target drum speed(s) and/or the target spindle speed(s) based on one or more cotton harvesting metrics included in the vehicle sensor data 720. For example, the speed selection circuitry 706 can increase and/or decrease the target drum speed(s) and/or the target spindle drive speed(s) based on the cotton harvesting metric(s) to improve efficiency of a cotton harvesting operation of the cotton harvester 100 (e.g., to increase flow of cotton material into the cotton harvester 100, to reduce loss of cotton material, etc.). In some examples, the cotton harvesting metric(s) can include a mass flow rate of cotton material into and/or through a portion of the cotton harvester 100, a loss corresponding to an amount of cotton material remaining in a field, a quality of the cotton material, etc.

At block 1312, the example system control circuitry 122 generates one or more first control signals (e.g., the first control signal(s) 801 of FIG. 8A) for the respective spindle drive pump(s) 326A, 326B of FIG. 3 based on the target spindle drive speed(s) and the calculated spindle drive speed(s). For example, the example pump control circuitry 710 of FIG. 7 generates the first control signal(s) 801 based on the spindle pump control loop 800 of FIG. 8A. In some examples, the pump control circuitry 710 calculates a difference (e.g., an error) between the target spindle drive speed(s) and the calculated spindle drive speed(s) for respective one(s) of the row units 116, and determines an output of a PID controller (e.g., the PID block 814 of FIG. 8A) based on the calculated difference. Further, the pump control circuitry 710 calculates a first feedforward value based on the target spindle drive speed(s) and the first feedforward model (e.g., represented in the first graph 820 of FIG. 8B). In some examples, the pump control circuitry 710 generates the first control signal(s) 801 based on the first feedforward value and the output of the PID controller.

At block 1314, the example system control circuitry 122 generates one or more second control signals (e.g., the second control signal(s) 901 of FIG. 9A) for the respective drum drive control valve(s) 322A, 322B of FIG. 3 based on the target drum speed(s) and the calculated drum speed(s). For example, the example valve control circuitry 712 of FIG. 7 generates the second control signal(s) 901 based on the drum valve control loop 900 of FIG. 9A. In some examples, the valve control circuitry 712 calculates a difference (e.g., an error) between the target drum speed(s) and a mean calculated drum speed (e.g., a mean of the calculated drum speeds across the row units 116A, 116B, 116C of the left system 302A of FIG. 3 and/or the row units 116D, 116E, 116F of the right system 302B of FIG. 3). In such examples, the valve control circuitry 712 determines an output of a PID controller (e.g., the PID block 914 of FIG. 9A) based on the calculated difference between the target drum speed(s) and the mean calculated drum speed. Further, the valve control circuitry 712 calculates a second feedforward value based on the target drum speed(s) and the second feedforward model (e.g., represented in the second graph 920 of FIG. 9B). In some examples, the valve control circuitry 712 generates the second control signal(s) 901 based on the second feedforward value and the output of the PID controller.

At block 1316, the example system control circuitry 122 generates one or more third control signals (e.g., the third control signal(s) 1002 of FIG. 10) for the respective bypass valve(s) 608 of FIG. 6. For example, the valve control circuitry 712 generates the third control signal(s) 1002 based on the bypass valve control loop 1000 of FIG. 10. In some examples, the valve control circuitry 712 calculates a difference (e.g., an error) between the target drum speed(s) and the calculated drum speed(s) for respective one(s) of the row units 116, and determines an output of a PID controller (e.g., the PID block 1014 of FIG. 10) based on the calculated difference. In some examples, the valve control circuitry 712 generates the third control signal(s) 1002 based on the output of the PID controller.

At block 1318, the example system control circuitry 122 provides the respective control signal(s) to the spindle drive pump(s) 326A, 326B of FIG. 3, the drum drive control valve(s) 322A, 322B, and/or the bypass valve(s) 608. For example, the pump control circuitry 710 provides the first control signal(s) 801 to respective one(s) of the spindle drive pump(s) 326A, 326B to control a first fluid flow from the spindle drive pump(s) 326A, 326B to the respective spindle drive motor(s) 306A, 306B. Further, the valve control circuitry 712 provides the second control signal(s) 901 to respective one(s) of the drum drive control valve(s) 322A, 322B to control a second fluid flow from the drum drive control valve(s) 322A, 322B to the respective drum drive motor(s) 318. Additionally, the valve control circuitry 712 provides the third control signal(s) 1002 to respective one(s) of the bypass valve(s) 608 to cause a portion of the second fluid flow to bypass the respective drum drive motor(s) 318.

At block 1320, the example system control circuitry 122 determines whether to update one or more lookup tables utilized by the system control circuitry 122. For example, the model control circuitry 708 determines to update one or more values of a first lookup table used to generate the first feedforward model (e.g., represented in the first graph 820 of FIG. 8B) and/or a second lookup table used to generate the second feedforward model (e.g., represented in the second graph 920 of FIG. 9B) periodically, upon completion of a cotton harvesting operation of the cotton harvester 100, in response to user input to a user interface of the cotton harvester 100, etc. In response to the model control circuitry 708 determining to update the lookup table(s) (e.g., block 1320 returns a result of YES), control proceeds to block 1322. Alternatively, in response to the model control circuitry 708 determining not to update the lookup table(s) (e.g., block 1320 returns a result of NO), control proceeds to block 1324.

At block 1322, the example system control circuitry 122 updates the feedforward model(s) and/or the lookup table(s) based on execution of one or more machine learning models. For example, the model control circuitry 708 executes the machine learning model(s) based on one or more vehicle metrics representative of an age and/or unit type of the cotton harvester 100, age and/or wear of one or more components of the cotton harvester 100, oil temperature(s) at respective location(s) of the cotton harvester 100, etc. In some examples, the model control circuitry 708 adjusts and/or updates one or more values of the lookup table(s) based on output(s) of the executed machine learning model(s).

At block 1324, the system control circuitry 122 determines whether to continue monitoring. For example, the data interface circuitry 702 determines to continue monitoring when new sensor data is obtained and/or during a cotton harvesting operation of the cotton harvester 100. In response to the data interface circuitry 702 determining to continue monitoring (e.g., block 1324 returns a result of YES), control returns to block 1302. Alternatively, in response to the data interface circuitry 702 determining not to continue monitoring (e.g., block 1324 returns a result of NO), control ends.

FIG. 14 is a block diagram of an example programmable circuitry platform 1400 structured to execute and/or instantiate the example machine-readable instructions and/or the example operations of FIG. 13 to implement the system control circuitry 122 of FIG. 7. The programmable circuitry platform 1400 can be, for example, a server, a personal computer, a workstation, a self-learning machine (e.g., a neural network), a mobile device (e.g., a cell phone, a smart phone, a tablet such as an iPad^{TM}), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the data interface circuitry 702, the parameter calculation circuitry 704, the speed selection circuitry 706, the model control circuitry 708, the pump control circuitry 710, the valve control circuitry 712, and the database 714.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1432, which may be implemented by the machine readable instructions of FIG. 13, may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowchart of FIG. 13 to effectively instantiate the circuitry of FIG. 7 as logic circuits to perform operations corresponding to those machine-readable instructions. In some such examples, the circuitry of FIG. 7 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine-readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine-readable instructions and/or operations represented by the flowchart of FIG. 13.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer-based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine-readable instructions. However, once configured, the FPGA circuitry 1600 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine readable instructions represented by the flowchart(s) of FIG. 13 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine readable instructions represented by the flowchart(s) of FIG. 13. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIG. 13. As such, the FPGA circuitry 1600 may be configured and/or structured to effectively instantiate some or all of the operations/functions corresponding to the machine readable instructions of the flowchart(s) of FIG. 13 as dedicated logic circuits to perform the operations/functions corresponding to those software instructions in a dedicated manner analogous to an ASIC. Therefore, the FPGA circuitry 1600 may perform the operations/functions corresponding to the some or all of the machine-readable instructions of FIG. 13 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High-Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine-readable instructions of FIG. 13 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine readable instructions represented by the flowchart(s) of FIG. 13 to perform first operation(s)/function(s), the FPGA circuitry 1600 of FIG. 16 may be configured and/or structured to perform second operation(s)/function(s) corresponding to a second portion of the machine readable instructions represented by the flowcharts of FIG. [Flowcharts], and/or an ASIC may be configured and/or structured to perform third operation(s)/function(s) corresponding to a third portion of the machine readable instructions represented by the flowchart of FIG. 13.

Some or all of the circuitry of FIG. 7 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 7 may be instantiated, for example, in one or more threads executing concurrently and/or in series. For example, the microprocessor 1500 of FIG. 15 may execute machine readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 7 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, unless otherwise stated, the term “above” describes the relationship of two parts relative to Earth. A first part is above a second part, if the second part has at least one part between Earth and the first part. Likewise, as used herein, a first part is “below” a second part when the first part is closer to the Earth than the second part. As noted above, a first part can be above or below a second part with one or more of: other parts therebetween, without other parts therebetween, with the first and second parts touching, or without the first and second parts being in direct contact with one another.

As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the described examples. In some examples, the descriptor “first” may be used to refer to an element in the detailed description, while the same element may be referred to in a claim with a different descriptor such as “second” or “third.” In such instances, such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real-world applications. For example, “approximately” and “about” may modify dimensions that may not be exact due to manufacturing tolerances and/or other real-world imperfections as will be understood by persons of ordinary skill in the art. For example, “approximately” and “about” may indicate such dimensions may be within a tolerance range of +/- 10% unless otherwise specified herein.

As used herein “substantially real time” refers to occurrence in a near instantaneous manner recognizing there may be real-world delays for computing time, transmission, etc. Thus, unless otherwise specified, “substantially real time” refers to real time + 1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example, an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been described that control rotation of a drum and spindles of a cotton harvesting row unit. Described examples utilize an example gearbox (e.g., a variable transmission gearbox) to drive rotation of the spindles based on a first input from a first motor, and drive rotation of the drum based on the first input from the first motor and a second input from a second motor. As a result, examples described herein enable the drum and the spindles to rotate at speeds independent of a ground speed of the cotton harvester and, thus, can improve efficiency of a cotton harvesting operation. Further, examples described herein can vary speeds of the drum and the spindles without necessitating a reversal of a rotational direction of the second motor, thus enabling a reduction in complexity of a hydraulic system operatively coupled to the second motor. Described systems, apparatus, articles of manufacture, and methods are accordingly directed to one or more improvement(s) in the operation of a machine such as a computer or other electronic and/or mechanical device.

The following claims are hereby incorporated into this Detailed Description by this reference. Although certain example systems, apparatus, articles of manufacture, and methods have been described herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a first motor operatively coupled, via a variable transmission gearbox, to a drum and spindles of a row unit of a cotton harvester;
a second motor operatively coupled to the drum via the variable transmission gearbox;
a pump operatively coupled to the first motor;
a valve operatively coupled to the second motor; and
at least one processor circuit configured to:
generate a first control signal for the pump, wherein the pump is configured to generate, responsive to the first control signal, a first fluid flow to the first motor, the first motor configured to cause rotation of the spindles based on the first fluid flow; and
generate a second control signal for the valve, wherein the valve is configured to control, responsive to the second control signal, a second fluid flow to the second motor, the first motor and the second motor configured to cause rotation of the drum based on the first fluid flow and the second fluid flow.

2. The apparatus of claim 1, wherein the pump is configured to adjust a first flow rate and a flow direction of the first fluid flow based on the first control signal, and the valve is configured to adjust a second flow rate of the second fluid flow based on the second control signal.

3. The apparatus of claim 1, wherein one or more of the at least one processor circuit is further configured to:
determine, based on first sensor data from a first sensor operatively coupled to the variable transmission gearbox, a first calculated rotational speed of the spindles;
determine, based on the first sensor data and second sensor data from a second sensor operatively coupled to the variable transmission gearbox, a second calculated rotational speed of the drum;
generate the first control signal based on a first difference between the first calculated rotational speed and a first target rotational speed for the spindles; and
generate the second control signal based on a second difference between the second calculated rotational speed and a second target rotational speed for the drum.

4. The apparatus of claim 3, wherein one or more of the at least one processor circuit is further configured to adjust at least one of the first target rotational speed or the second target rotational speed based on a cotton harvesting metric, the cotton harvesting metric including at least one of a mass flow rate of cotton material into the cotton harvester, a loss associated with the cotton material, or a quality of the cotton material.

5. The apparatus of claim 1, wherein one or more of the at least one processor circuit is further configured to:
execute a machine learning model based on a metric associated with the cotton harvester;
adjust a value of at least one of a first lookup table or a second lookup table based on a result of the execution, wherein the first lookup table relates first rotational speeds of the first motor to first current values for the first control signal, and the second lookup table relates second rotational speeds of the second motor to second current values for the second control signal;
select, based on the first lookup table, a first current value for the first control signal; and
select, based on the second lookup table, a second current value for the second control signal.

6. The apparatus of claim 5, wherein the metric includes at least one of an oil temperature of the cotton harvester, a unit type of the cotton harvester, or an age of one or more components of the cotton harvester.

7. The apparatus of claim 1, wherein the row unit is a first row unit, the valve is a first valve, and wherein one or more of the at least one processor circuit is further configured to generate a third control signal for a second valve fluidly coupled between the first valve and a second row unit of the cotton harvester, wherein the second valve is configured to, responsive to the third control signal, redirect a portion of the second fluid flow to the second row unit.

8. A non-transitory machine-readable medium comprising instructions that, when executed, cause at least one processor circuit to:
generate a first control signal for a pump operatively coupled to a first motor, the first motor operatively coupled, via a variable transmission gearbox, to a drum and spindles of a row unit of a cotton harvester, wherein the pump is configured to generate, responsive to the first control signal, a first fluid flow to the first motor, the first motor configured to cause rotation of the spindles based on the first fluid flow; and
generate a second control signal for a valve operatively coupled to a second motor, the second motor operatively coupled to the drum via the variable transmission gearbox, wherein the valve is configured to control, responsive to the second control signal, a second fluid flow to the second motor, the first motor and the second motor configured to cause rotation of the drum based on the first fluid flow and the second fluid flow.

9. The non-transitory machine-readable medium of claim 8, wherein the pump is configured to adjust a first flow rate and a flow direction of the first fluid flow based on the first control signal, and the valve is configured to adjust a second flow rate of the second fluid flow based on the second control signal.

10. The non-transitory machine-readable medium of claim 8, wherein the instructions, when executed, cause one or more of the at least one processor circuit to:
determine, based on first sensor data from a first sensor operatively coupled to the variable transmission gearbox, a first calculated rotational speed of the spindles;
determine, based on the first sensor data and second sensor data from a second sensor operatively coupled to the variable transmission gearbox, a second calculated rotational speed of the drum;
generate the first control signal based on a first difference between the first calculated rotational speed and a first target rotational speed for the spindles; and
generate the second control signal based on a second difference between the second calculated rotational speed and a second target rotational speed for the drum.

11. The non-transitory machine-readable medium of claim 10, wherein the instructions, when executed, cause one or more of the at least one processor circuit to adjust at least one of the first target rotational speed or the second target rotational speed based on a cotton harvesting metric, the cotton harvesting metric including at least one of a mass flow rate of cotton material into the cotton harvester, a loss associated with the cotton material, or a quality of the cotton material.

12. The non-transitory machine-readable medium of claim 8, wherein the instructions, when executed, cause one or more of the at least one processor circuit to:
execute a machine learning model based on a metric associated with the cotton harvester;
adjust a value of at least one of a first lookup table or a second lookup table based on a result of the execution, wherein the first lookup table relates first rotational speeds of the first motor to first current values for the first control signal, and the second lookup table relates second rotational speeds of the second motor to second current values for the second control signal;
select, based on the first lookup table, a first current value for the first control signal; and
select, based on the second lookup table, a second current value for the second control signal.

13. The non-transitory machine-readable medium of claim 12, wherein the metric includes at least one of an oil temperature of the cotton harvester, a unit type of the cotton harvester, or an age of one or more components of the cotton harvester.

14. The non-transitory machine-readable medium of claim 8, wherein the row unit is a first row unit, the valve is a first valve, and wherein the instructions, when executed, cause one or more of the at least one processor circuit to generate a third control signal for a second valve fluidly coupled between the first valve and a second row unit of the cotton harvester, wherein the second valve is configured to, responsive to the third control signal, redirect a portion of the second fluid flow to the second row unit.

15. A method comprising:
generating a first control signal for a pump operatively coupled to a first motor, the first motor operatively coupled, via a variable transmission gearbox, to a drum and spindles of a row unit of a cotton harvester, wherein the pump is configured to generate, responsive to the first control signal, a first fluid flow to the first motor, the first motor configured to cause rotation of the spindles based on the first fluid flow; and
generating a second control signal for a valve operatively coupled to a second motor, the second motor operatively coupled to the drum via the variable transmission gearbox, wherein the valve is configured to control, responsive to the second control signal, a second fluid flow to the second motor, the first motor and the second motor configured to cause rotation of the drum based on the first fluid flow and the second fluid flow.

16. The method of claim 15, further including:
determining, based on first sensor data from a first sensor operatively coupled to the variable transmission gearbox, a first calculated rotational speed of the spindles;
determining, based on the first sensor data and second sensor data from a second sensor operatively coupled to the variable transmission gearbox, a second calculated rotational speed of the drum;
generating the first control signal based on a first difference between the first calculated rotational speed and a first target rotational speed for the spindles; and
generating the second control signal based on a second difference between the second calculated rotational speed and a second target rotational speed for the drum.

17. The method of claim 16, further including adjusting at least one of the first target rotational speed or the second target rotational speed based on a cotton harvesting metric, the cotton harvesting metric including at least one of a mass flow rate of cotton material into the cotton harvester, a loss associated with the cotton material, or a quality of the cotton material.

18. The method of claim 17, further including:
executing a machine learning model based on a metric associated with the cotton harvester;
adjusting a value of at least one of a first lookup table or a second lookup table based on a result of the execution, the first lookup table to relate first rotational speeds of the first motor to first current values for the first control signal, the second lookup table to relate second rotational speeds of the second motor to second current values for the second control signal;
selecting, based on the first lookup table, a first current value for the first control signal; and
selecting, based on the second lookup table, a second current value for the second control signal.

19. The method of claim 18, wherein the metric includes at least one of an oil temperature of the cotton harvester, a unit type of the cotton harvester, or an age of one or more components of the cotton harvester.

20. The method of claim 15, wherein the row unit is a first row unit, the valve is a first valve, and further including generating a third control signal for a second valve fluidly coupled between the first valve and a second row unit of the cotton harvester, wherein the second valve is configured to, responsive to the third control signal, redirect a portion of the second fluid flow to the second row unit.
